(19) United States
(12) Patent Application Publication
(10) Pub. No.: US 2017/0040933 A1
(43) Pub. Date: Feb. 9, 2017

(54) PHOTOVOLTIAC NANOGRID SYSTEMS

(71) Applicant: Grid+ Advisors, LLC, San Carlos, CA (US)

(72) Inventor: William S. Vogel, San Carlos, CA (US)

(21) Appl. No.: 15/227,465

(22) Filed: Aug. 3, 2016

Related U.S. Application Data
(60) Provisional application No. 62/200,209, filed on Aug. 3, 2015.

(51) Int. Cl. H02S 20/32; H02S 20/25; H02S 40/34; H02S 30/10; H02S 40/36

(52) U.S. Cl. CPC H02S 20/32; H02S 30/10; H02S 40/36; H02S 40/34; H02S 20/25

(57) ABSTRACT

A photovoltaic nanogrid system is disclosed. One or more pre-wired frames each having a top, sun-facing side may be configured to receive one or more photovoltaic (PV) modules mounted thereon. The one or more pre-wired frames may include electrically and structurally connected support beams connectable to the one or more photovoltaic modules. A wire management system embedded within the one or more pre-wired frames may include modular conduits that gather and route wiring to/from the one or more pre-wired frames. A structural-electrical integration system may support the one or more pre-wired frames and may route power among the one or more pre-wired frames.

### CROSS-REFERENCE TO RELATED APPLICATIONS

This application claims the benefit of U.S. Provisional Patent Application Ser. No. 62/200,209, entitled “PHOTOVOLTAIC NANOGRID SYSTEMS,” filed Aug. 3, 2015, the disclosure of which is incorporated by reference herein in its entirety.

### BACKGROUND OF THE DISCLOSURE

Interest in microgrids, which are localized, controlled groups of energy resources and loads, has exploded in recent years. Microgrids allow localities to make decisions about how to prioritize or otherwise control distribution of power, including power generated outside the microgrid (e.g., from the macro power grid) and energy resources located within the microgrid, to various consumers. For example, one microgrid might place an emphasis on renewable energy generation and include within its purview clean energy generation plants, such as photovoltaics, wind turbines, and geothermal power plants. Another microgrid might value resiliency and redundancy, especially for powering critical infrastructure, like hospitals. Still other microgrids might focus on cost reduction by using energy storage media (e.g., batteries) to store electricity generated at off-peak times and deliver electricity at peak times.

Some microgrids are off-grid systems that operate completely independently from the macro power grid while others can be connected and disconnected, or islanded, from the macro power grid as needed—to maintain power during a utility outage, for example. Microgrids are typically understood to exist at the community level. Nanogrids, on the other hand, can be defined both as small-scale microgrids or the smallest individually-controllable nodes of a microgrid.

### SUMMARY OF THE DISCLOSURE

A photovoltaic nanogrid system is disclosed. A photovoltaic nanogrid system can include a number of modular nanogrid frames, a multi-function wire management system, a structural support system, nanogrid network controllers, and energy space system and subscriber interfaces. The modular nature of the photovoltaic nanogrid systems permits the interconnection of many individual systems that can operate both individually and as a group.

The photovoltaic nanogrid system may include one or more pre-wired frames each having a top, sun-facing side may be configured to receive one or more photovoltaic (PV) modules. The pre-wired frames may include electrically and structurally connected support beams that are connectable to the photovoltaic modules. A wire management system embedded within the pre-wired frames may include modular conduits that gather and route wiring between pre-wired frames. A structural-electrical integration system may support the one or more pre-wired frames and may route power and electrical signals among the pre-wired frames.

The pre-wired frames may further include one or more electrically and structurally connectable support beams and/or multi-layered sub-panels connected to an under side of the pre-wired frames. The sub-panels may include a wire/tube matrix fabricated from composite materials, wiring, and connectors. The composite materials may be formed from a single fiber type.

An under side of the pre-wired frames may further include one or more ports and/or jacks to integrate under-canopy components include one or more of a microinverter, lighting, a sensor, a battery, or a charger. The pre-wired frames may be assembled from poltruded and/or pre-formed, multidirectional fiber tubes, used as both structural beams and conduits that receive wires. The pre-wired frames may be further assembled from one or more of fiber tubes, solid rods or outer tubes combined with frame-beam wires.

A series of ports or jacks may be located at points along support beams on an underside of the one or more pre-wired frames.

The photovoltaic nanogrid system may further include frame embedded wire management and extension points to permit groups of PV modules to be installed as cohesive power units. The photovoltaic nanogrid system may further include routing wires to combiner conduits that facilitate the interconnection between individual PV nanogrid systems. The modular conduits of the wire management system may route PV extension, electrical load, and network wires between adjacent frames via extension connectors. In some embodiments, the PV extension wires might run in one direction, and the electrical load and network wires might run in a generally orthogonal direction.

The structural-electrical integration system may support a matrix of one or more frames and one or more conduits to route power and other electrical loads. The conduits may be enclosed within canopy extensions comprising one or more of beams, horizontal trusses, or suspension cables. The conduits may further include hardware interfaces that provide structural integration. The hardware interfaces may include one or more of ball joints, sleeve clamps, loop brackets, truss brackets, axle brackets, and truss systems.

The photovoltaic nanogrid system may further include one or more network controllers configured to manage one or more components of the photovoltaic nanogrid system. The network controllers may be configured to manage one or more of the PV modules, inverters, switches, storage, loads and data network circuits, ports, or jacks. The network controllers may each include a layer to monitor and control the one or more pre-wired frames, a layer to control components, and a layer to control a topology of the system. The one or more network controllers may be configured to partition the system into intelligent area functions that serve specific subscribers.

In another example, the photovoltaic nanogrid system may include one or more photovoltaic (PV) modules mounted on a top, sun-facing side of one or more pre-wired frames. The one or more pre-wired frames may include electrically and structurally connected support beams connectable to the one or more photovoltaic modules. A wire management system embedded within the one or more pre-wired frames may include modular conduits that gather and route wiring to/from the one or more pre-wired frames. A structural-electrical integration system may support the one or more pre-wired frames and may route power among the one or more pre-wired frames.

The photovoltaic nanogrid systems disclosed herein may be leveraged in a wide range of applications located near electricity demand where traditional photovoltaic systems are not deployable, such as: around the perimeter of existing power plants; along linear infrastructure courses, like aqueducts, pipelines, roadways, and train tracks; as canopies in a community's open spaces; as rooftop canopies for roofs not otherwise suitable for photovoltaic installations; and on soft soil that is otherwise infeasible for ground mounted solar plants.

### BRIEF DESCRIPTION OF THE DRAWINGS

For a fuller understanding of the inventive embodiments, reference is made to the following description taken in connection with the accompanying drawings in which:

FIG. 1 shows a schematic view of photovoltaic (“PV”) nanogrid system, in accordance with various embodiments.

FIG. 2 shows a top elevation view of an array of PV nanogrid systems, in accordance with some embodiments.

FIG. 3 depicts a schematic wiring diagram that illustrates the electrical extensibility of a PV nanogrid system, in accordance with various embodiments.

FIGS. 4A-4M depict exemplary frames, in accordance with various embodiments.

FIG. 5 depicts frame-beam wires, displayed vertically, corresponding to nanogrid wire sets for load and network circuits.

FIG. 6 shows a wire connector design of a basic frame, in accordance with some embodiments.

FIG. 7 shows a schematic view of modular frame PV expansion, in accordance with some embodiments.

FIGS. 8A and 8B show schematic views of various frame-to-frame structural extension members, in accordance with some embodiments.

FIG. 9 shows a schematic view of string-to-extension connector options, in accordance with some embodiments.

FIG. 10 shows a schematic view of nanogrid port connector options, in accordance with some embodiments.

FIG. 11 shows various views of pre-assembly and module mounting features of a PV nanogrid system, in accordance with some embodiments.

FIG. 12 shows a perspective view of a PV nanogrid system, in accordance with some embodiments.

FIG. 13 shows various options for providing structural integration, in accordance with some embodiments.

FIGS. 14A-14D show examples of suitable physical interfaces between frames and substructure, in accordance with some embodiments.

FIG. 15 shows various examples of truss supports, in accordance with some embodiments.

FIG. 16 shows various truss-pole and truss-cable variations, in accordance with some embodiments.

FIG. 17 shows a nanogrid control system framework, in accordance with some embodiments.

FIG. 18 shows a schematic view of an exemplary Nanogrid Network Controller (NNC), in accordance with some embodiments.

FIG. 19 shows an exemplary nanogrid system for use in perimeter plants and border control.

FIG. 20 shows an exemplary nanogrid system for use as a linear infrastructure plant above an aqueduct.

### DETAILED DESCRIPTION OF THE PREFERRED EMBODIMENTS

PV nanogrid systems are disclosed. The systems can feature photovoltaic modules mounted on pre-wired, lightweight, and strong structural-electrical components that can connect multiple PV modules per frame with Nanogrid components. These modular units can include electrically and structurally connectable support beams and/or multi-layered sub-panels, which facilitate the combination of many PV nanogrid systems into scalable configurations for safe and secure overhead systems (e.g. “smart canopies”), near surface/smart-roofing configurations, and other applications. Modular PV systems such as the ones disclosed herein advantageously reduce on-site installation time and costs by allowing the installation of multiple PV modules on a single frame, in contrast with the typical “erector set solar” model, which requires multiple installation steps per PV module. Unlike typical ground mount, rooftop, and parking lot structural systems, the PV nanogrid systems disclosed herein require fewer system components and on-site installation steps by integrating structures, wires, connectors, and ports, thus ensuring efficient deployment even over large areas.

These modular framing apparatus can help localities accelerate renewable energy expansion by complimenting traditional, limited-deployment methods. Historically speaking, “usable-justifiable” areas suitable for renewable energy plants, such as solar and wind plants, for example, represent less than 15% of available acreage in a given locality. The PV nanogrid system is the core scalar component of an extensible renewable energy plant that can substantially increase the amount of user-justifiable area in a locality. However, managing gigawatts of hybrid renewable assets outside of traditional, isolated power plants has numerous implications that require intelligent structural platforms suitable for installation areas not typically suited for renewable energy plants. The flexible configuration standards of the PV nanogrid systems disclosed herein enable such management of extensible energy spaces making them suitable complementary energy assets for a locality.

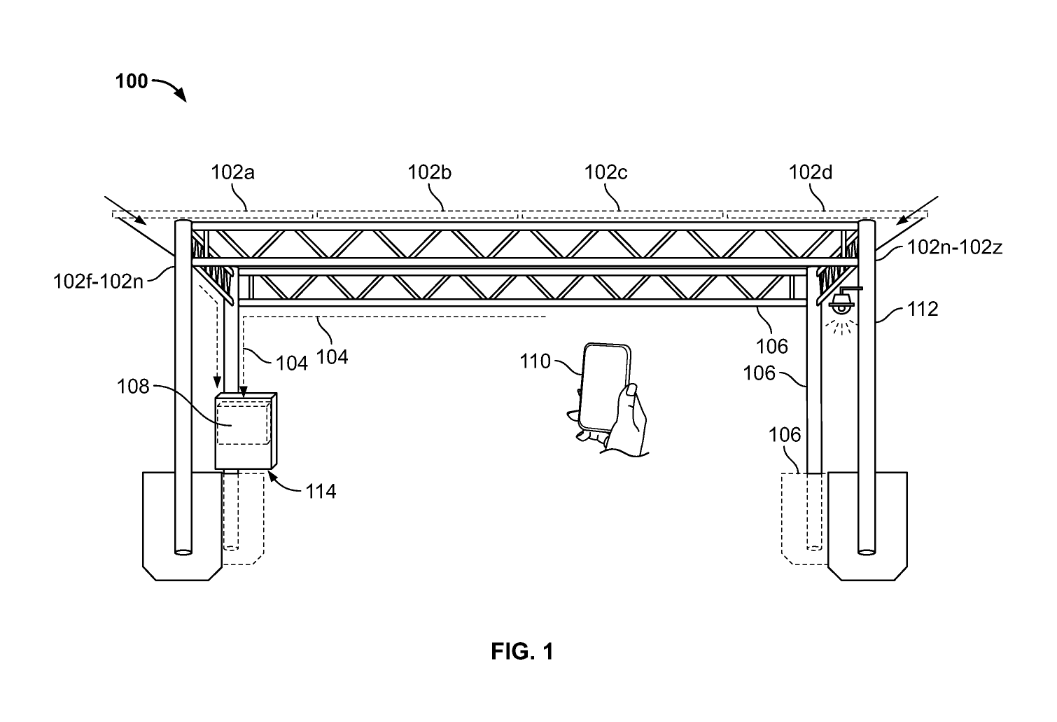

FIG. 1 shows a schematic view of photovoltaic (“PV”) nanogrid system 100, in accordance with various embodiments. PV nanogrid system 100 is an example of a smart framing system that integrates PV modules with related devices to operate as a stand-alone microgrid or in conjunction with additional PV nanogrid systems as a microgrid node. PV nanogrid system 100 can include one or more modular nanogrid frames 102a-102z, a multi-function wire management system 104, smart frame elements 106, nanogrid network controllers 108, energy space system and subscriber interfaces 110, and smart canopy customization options 112.

Modular nanogrid frames 102a-102z can include PV modules mounted on the top, sun-facing side. The bottom side of modular nanogrid frames 102a-102z can include a number of ports and/or jacks to integrate various under-canopy components such as microinverters, lighting, sensors, batteries, and chargers, for example.

Multi-function wire management system 104 can be provided for extensible variations of PV groupings as well as loads and data networks. These embedded wiring systems may include modular frames capable of extending wiring to adjacent frames as well as modular conduits within support structures that gather and route wiring from the modular frames. The conduits can advantageously keep wires hidden and protected from weather, vandalism and theft. Sub-frame materials can be made from fiber composites (e.g., aramid, carbon, glass fiber composites) or other lightweight materials that can encapsulate, enclose or hide wiring for solar power as well as data networks and loads.

Each modular frame can route PV, nanogrid, and network wires. When these wires are connected, multiple frames form an organized matrix of few to many frames and dozens to thousands of PV modules, depending on the configuration. The associated wires management systems can support:
1. Integrating individual PV modules and related components into nanogrid frames that, when interconnected, combine into repeatable plant and/or MicroGrid formations;
2. Integrating safe, secure, and controllable loads for energy space services (e.g. “virtual building”), such as lighting, fans, charging and “smart plugs”, intended for outdoor as well as non-insulated/open/mobile structures such as barns, warehouses and shipping containers; and
3. Data network integration, such as Power Over Ethernet (“POE”), with controllable power and data ports and ultra-secure wiring to ensure connectivity for sensors, security and subscriber access devices.

Structural-Electrical Integration Systems (e.g. smart frame elements 106) can support a matrix of frames and conduits to route power and other electrical loads to balance of plant components 114 of PV nanogrid system 100. The term “balance of plant” as used herein refers to all components of a PV power plant related to generation, storage, and transfer of energy aside from the PV modules.

Foundational, modular support structures (smart frame elements 106) encapsulate the above wire management systems into architectural variations to enable secure, attractive and extensible deployment of distributed renewable power, in many cases, elevated above agricultural, community, and perimeter and linear infrastructure areas. They can also be used to increase the footprint of present PV plants as well as enable new power plants in marginal and environmentally sensitive locations.

Nanogrid network controllers 108 can facilitate the remote management of key components of PV nanogrid system 100, including modules, inverters, switches, storage, loads and data network circuits, as well as ports and jacks, for example.

Energy space system and subscriber interfaces 110 can request/enable the use of energy spaces and/or related resources on an ad-hoc basis as well as automatically instigate awareness modes based on presence, proximity, etc.

Smart canopy customization options 112 may include various options for architectural, environmental and functional features such as lighting, cameras, rain gutters, shades, acoustics, weather stations, wireless, etc.

The nanogrid network controllers 108 and energy space system and subscriber interfaces 110 manage canopy spaces and provision various services. Smart framing must anticipate structural/functional adaptation (e.g., the smart canopy customization options 112).

The description that follows describes various embodiments of all of these system components as well as how to make and use a smart framing system, as the core unit of modular designs that can reduce the cost and increase the value of distributed renewables.

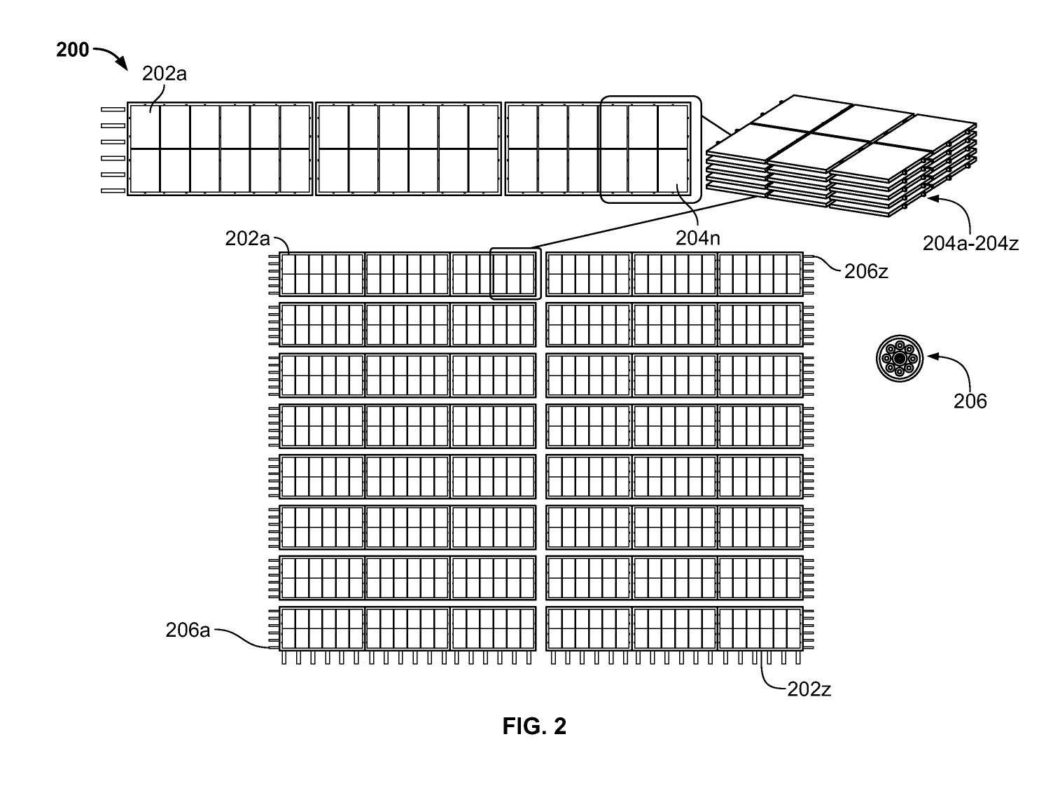

FIG. 2 shows a top elevation view of PV nanogrid system 200 in accordance with some embodiments. PV nanogrid system 200 includes structurally and electrically interconnected nanogrid frames 202a-202z. Nanogrid frames 202a-202z include PV modules mounted thereon, which may be organized into shippable units 204a-204z. Nanogrid frames 202a-202z can integrate and organize the various PV, nanogrid, and network wires 206a-206z required for the system. Although shippable units 204a-204z are depicted as including six PV modules per unit, and nanogrid frames 202a-202z support two shippable capacity units per frame, a person of skill in the art would understand that other arrangements are possible and potentially preferable depending on the shape and size of the nanogrid or microgrid to be built.

The particular arrangement of PV nanogrid systems 200 shown in FIG. 2 is for an extra-large canopy configuration. This configuration is but one of a multitude of possible configurations made possible by the PV nanogrid system disclosed herein. Indeed, the modular and extensible nature of PV nanogrid system 200 for distributed renewable energy systems enables remarkable site diversity, thereby increasing the usable area in a locality suitable for renewable energy plants. Thus, PV nanogrid systems facilitate deployment of renewable energy assets near demand and electricity grids in areas that were not previously available for such installations, such as areas complementary to existing plants, as well as for areas where traditional ground mount and rooftop installation are not feasible, for example.

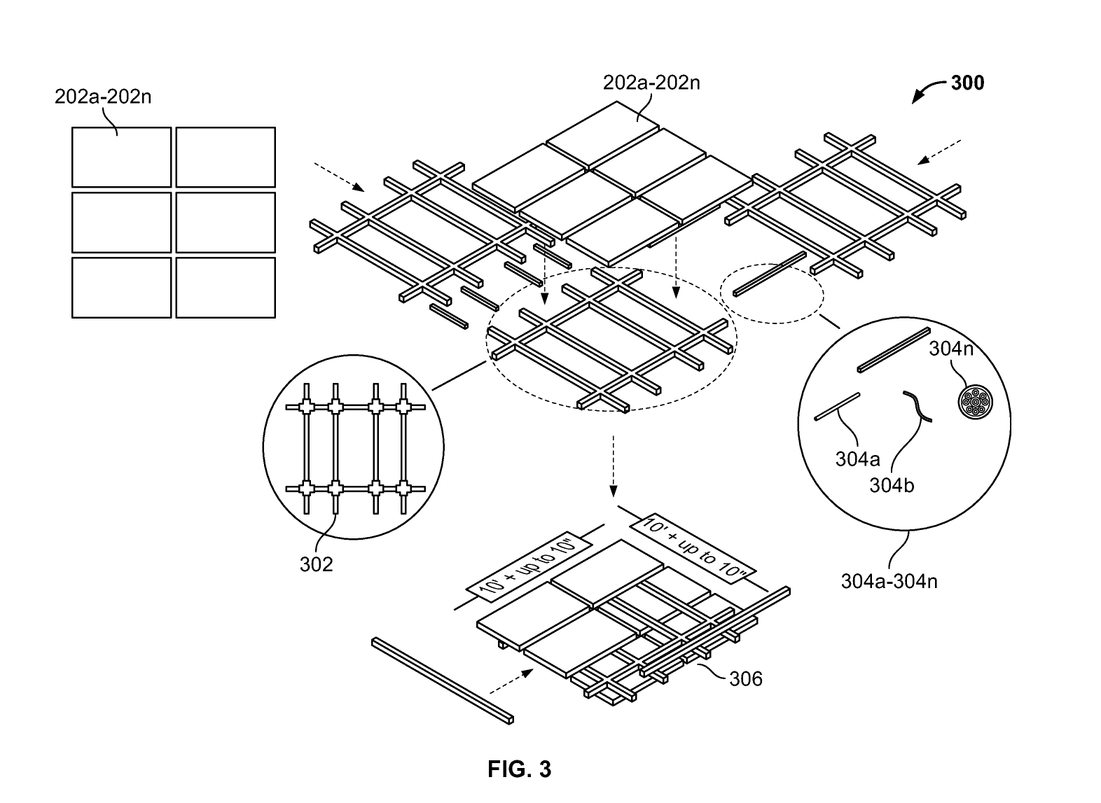

FIG. 3 depicts electrical and structural extensible PV nanogrid system 300, in accordance with various embodiments. Electrically and structurally extendable components may include, for example, modular nanogrid structures 302 composed of inner tube rods 304a, cables 304b, and cable wiring conduits 304n. The electrically extensible components may further include optional outer framing 306 for architectural support and for wind resistance.

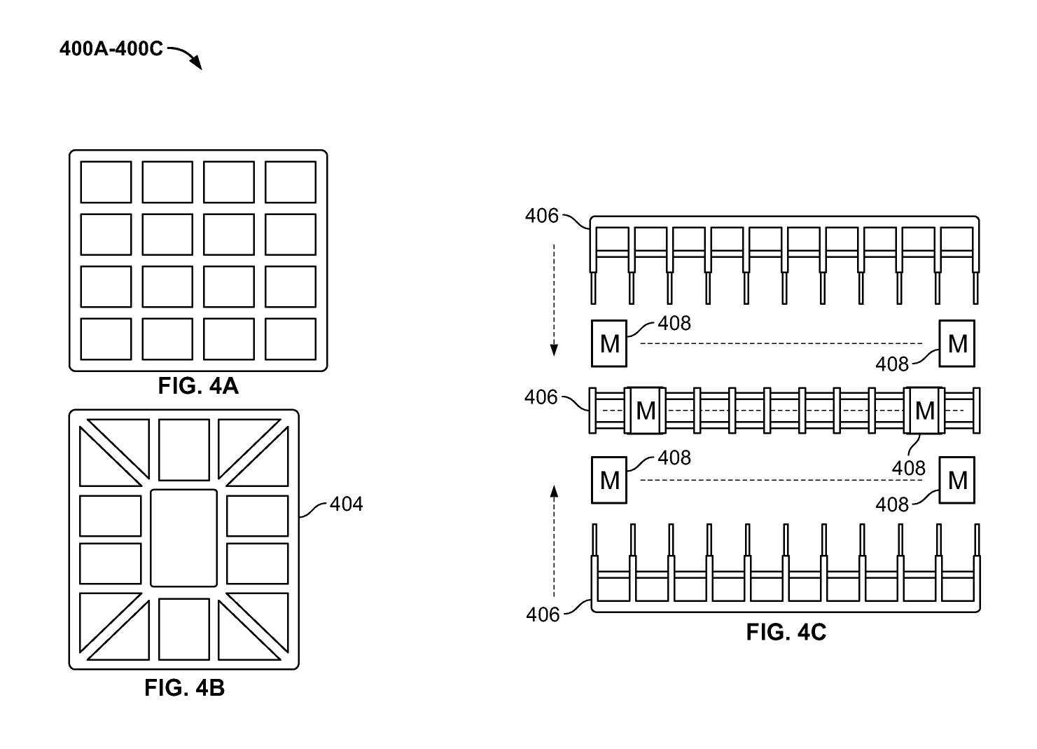

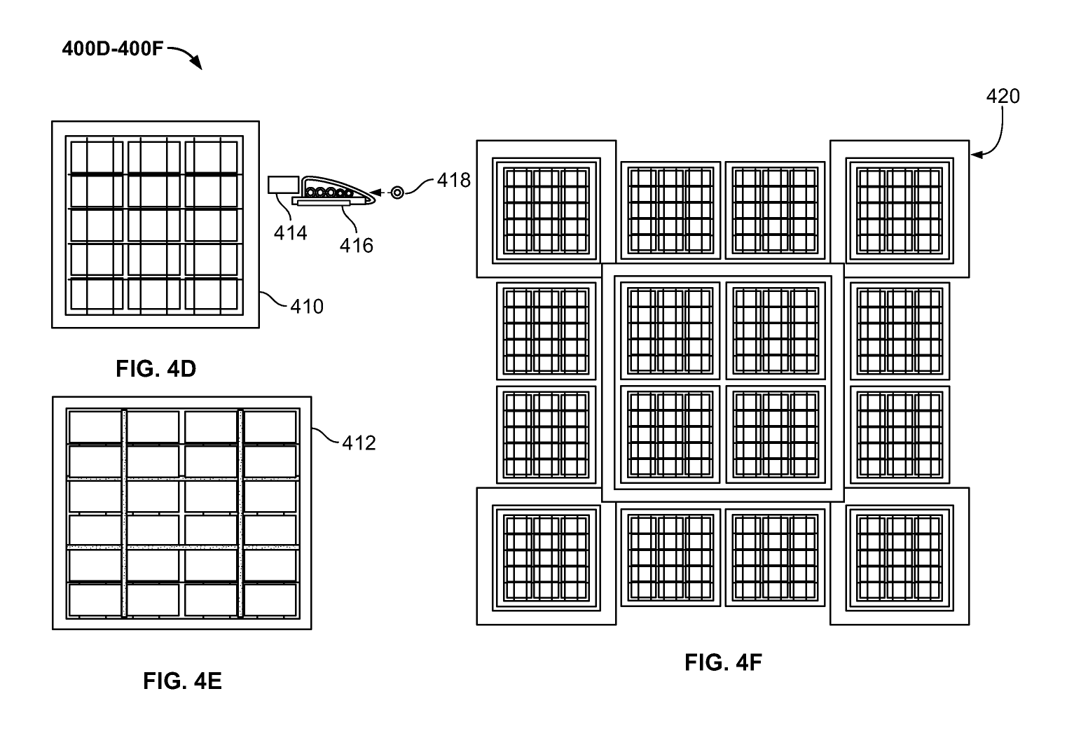

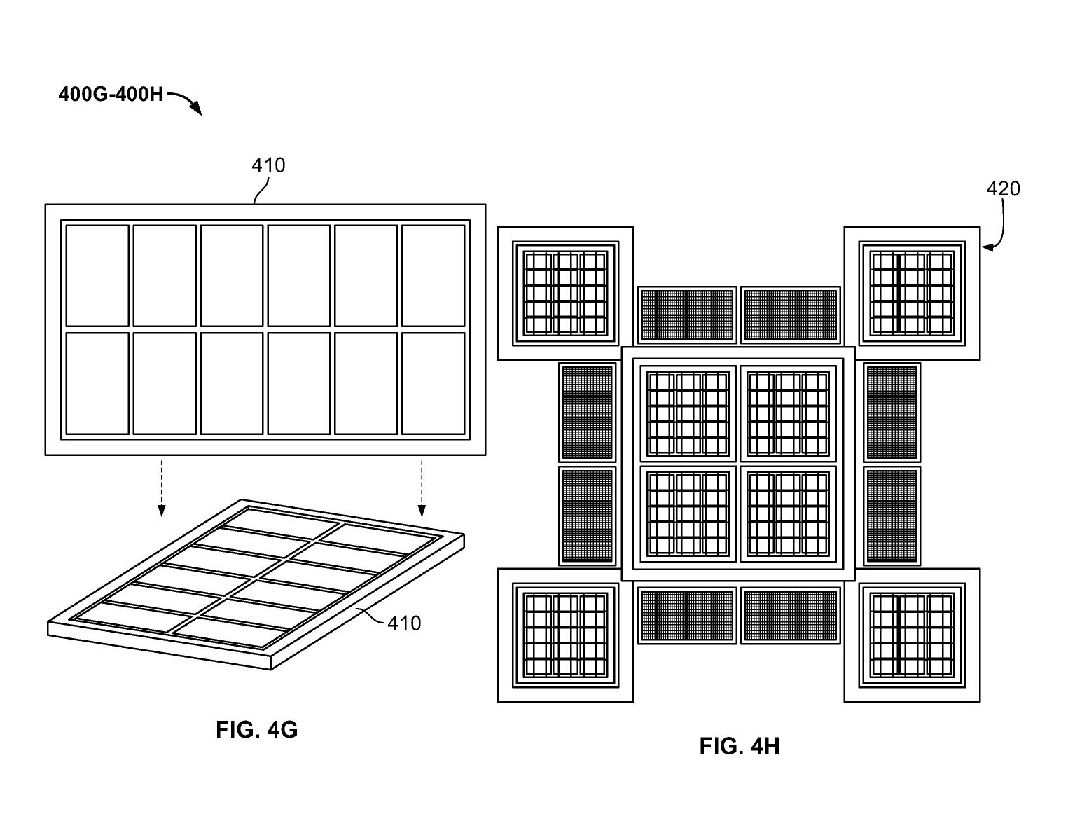

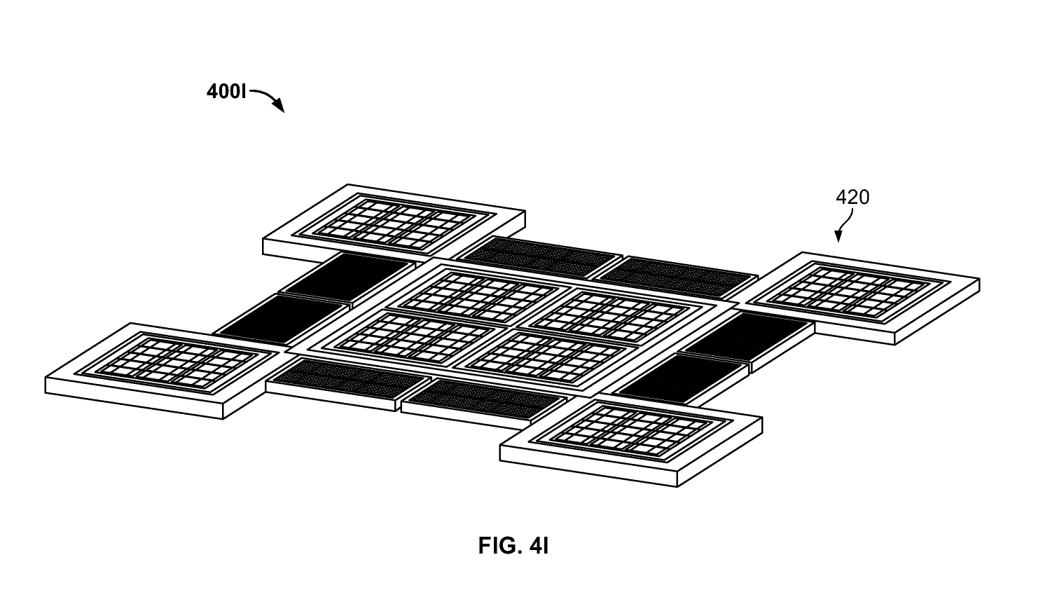

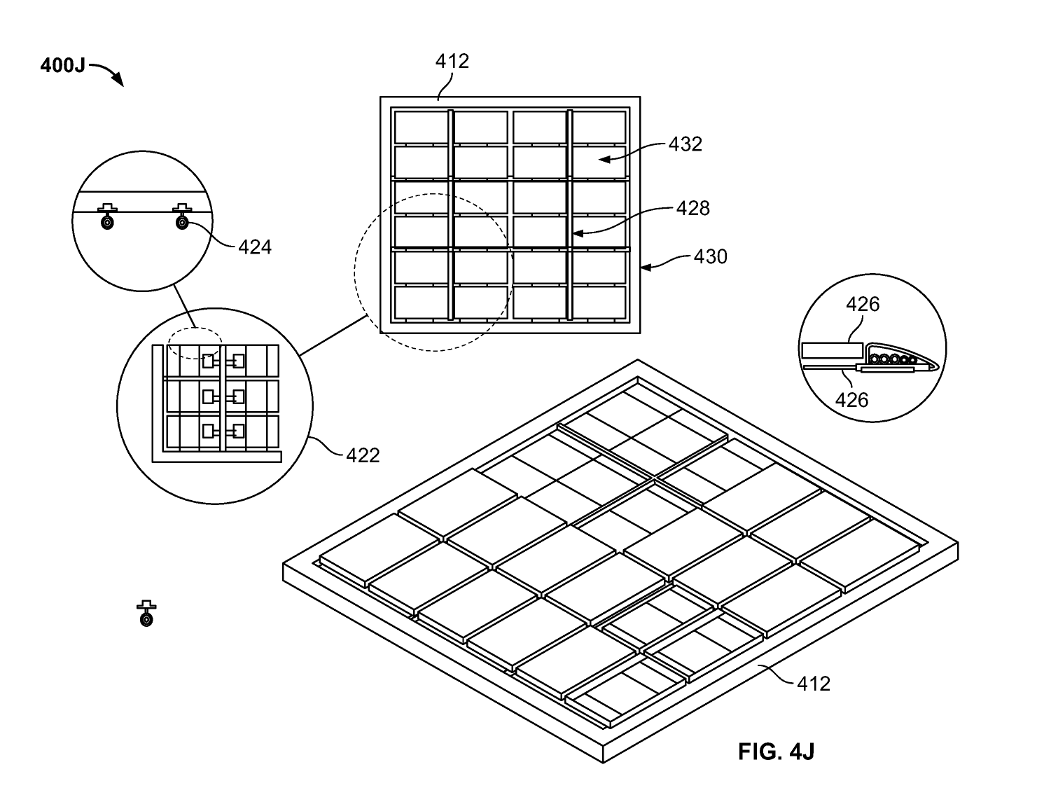

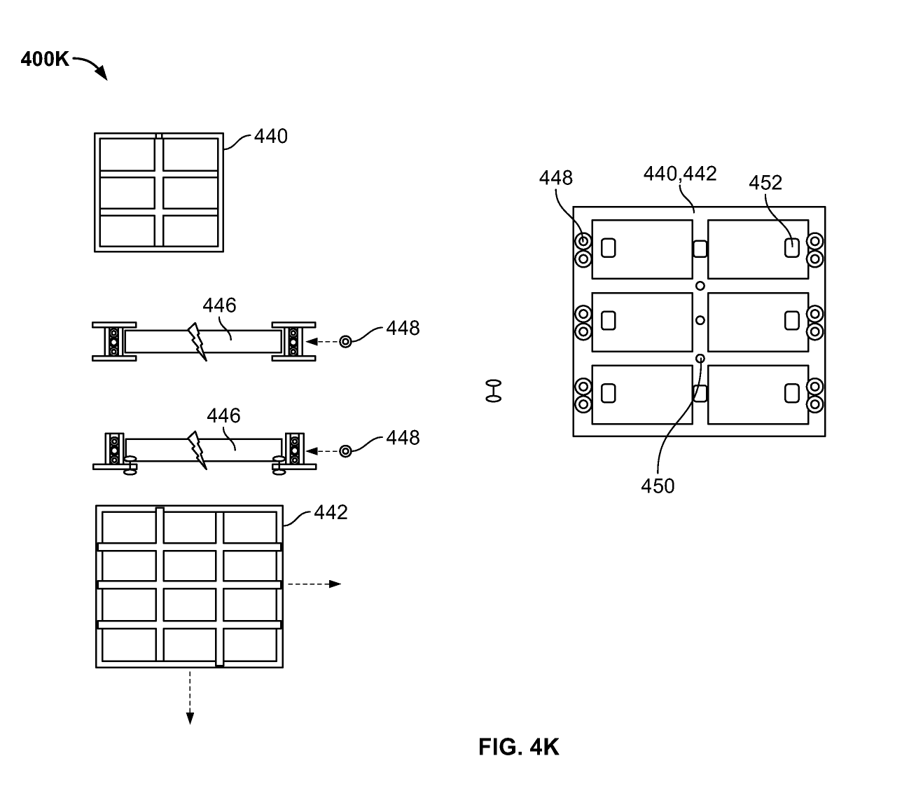

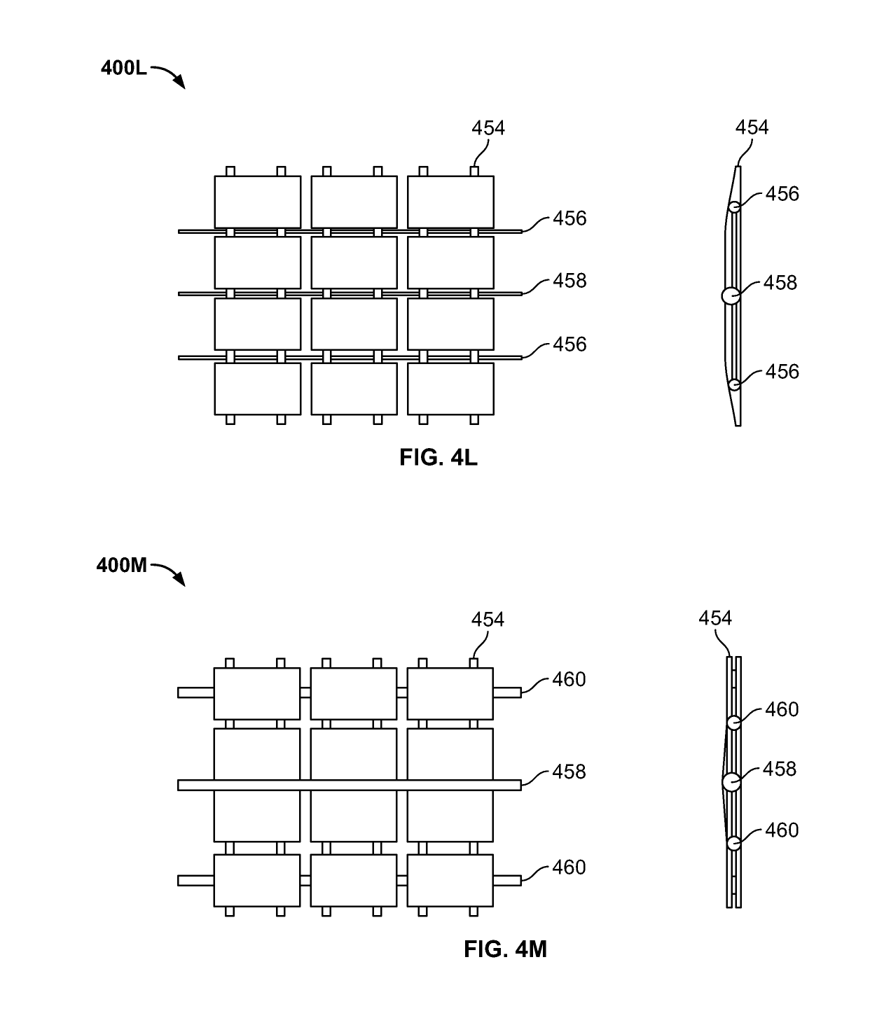

There are many conceivable physical embodiments of modular wire-embedded designs that enable the functional characteristics of electrical/structural extensible framing. FIGS. 4A-4M depict exemplary frames 400A-400M, in accordance with various embodiments. The following descriptions of the examples of such designs are not meant to be exhaustive and one or more of the following can be used together in a single PV nanogrid system or in a microgrid formed from interconnected PV nanogrid systems:
1. Base Frames are sub-frame matrices (e.g., a square matrix 402, a spider matrix 404, a multi-array assembly 406, etc.) that may be mounted directly underneath the PV modules 408;
2. Module Enclosed Frames 410, 412 (FIGS. 400D, 400E) are outer framing members that can surround and enclose PV modules, which may include panels 414, framing 416, and wiring, 418;
3. Composite Cable Frames are composite cable matrices mounted under and/or around PV modules;
3. Cable/Frame Combinations 420 (FIG. 400F, 400H, 400I) are combinations of module-enclosed frames with cables and/or composite wires mounted beneath the PV module 426s, which may include modular nanogrid understructure 422 that may itself include connectors 424, internal frames 428, and outer frames 430 overlying suspension rails 432;
4. Frames with Enclosed Trackers are frames that allow one or more of the PV modules to rotate within the frame itself;
5. Tracker Frames are frames that enable all modules to rotate as one unit;
6. Sub-Panels are solid frames that provide roof-like coverage and/or support for thin film PV modules; and
7. Ceiling tile-embedded wiring and component integrations systems, which are wired ceiling panels suspended below framed PV modules.

FIG. 4K depicts a solid frame 440 and a multipanel frame 442, which may have an open framing bolted configuration 442 or an enclosed frame configuration 444, each including panels 446, and wires 448. The solid frame 440 and multipanel frame 442 may further include module to grid connectors 448, low voltage DC connections 450, and Ethernet connections 452.

FIGS. 400L and 400M each depict composite slats 454 that may include cable wire 456, tube or cable 458, an/or slat wire 460.

The basic framing elements described above can be combined and may include various substructures, such as beams, cables, rails, and trusses, for example, to form a multitude of framing variations. Each frame embeds wire management and extension points, thereby allowing groups of PV modules to be installed as power units, while routing wires to combiner conduits that facilitate the interconnection between the individual PV nanogrid systems.

Although the many of the frames disclosed above may be formed from the types of aluminum alloys used in most solar plants today, recent advances in composite materials and manufacturing techniques open up the possibility of erecting elegant structures capable of utilizing open and overhead areas for PV plants that were not previously available. Each of these framing options (1-7) secures wires within structures (e.g., tubes, beams, panels, cables, or moldings) using fiber-wire, poltruded, layered composites and/or hybrid fiber-metal composites. There are other benefits as well. For instance, the use of outer framing can eliminate the need for module clamps and bolts.

Although canopies can be made from a single one of the frame options disclosed above, the value of structural diversity comes into play when applications require spanning capacity, architectural elegance, expression and function.

Though physical layout and connectors vary among frame options (A-H), the apparatus layout as well as the inherent benefits remains consistent.

For convenience, the remainder of disclosure will describe the various other components of PV nanogrid system 100 interacting with a base frame that includes a sub-frame wire/tube matrix fabricated from composite materials, wiring, and connectors. The base frame described will include general-purpose mounting and integration hardware, which may also be compatible with one or more of the other frame designs, that can accommodate a diversity of PV module sizes and thicknesses. In this manner, identical hardware that can accommodate PV modules of different sizes may be used with various different frame designs.

The composite materials used to make unified wire-frames may be formed from a single fiber type (e.g. carbon fiber, glass, or nylon) and/or combinations of fiber types. Unified wire-frames can include cables with varying dimensions, which may be chosen along with the material type, for example, based on loading requirements of the frame.

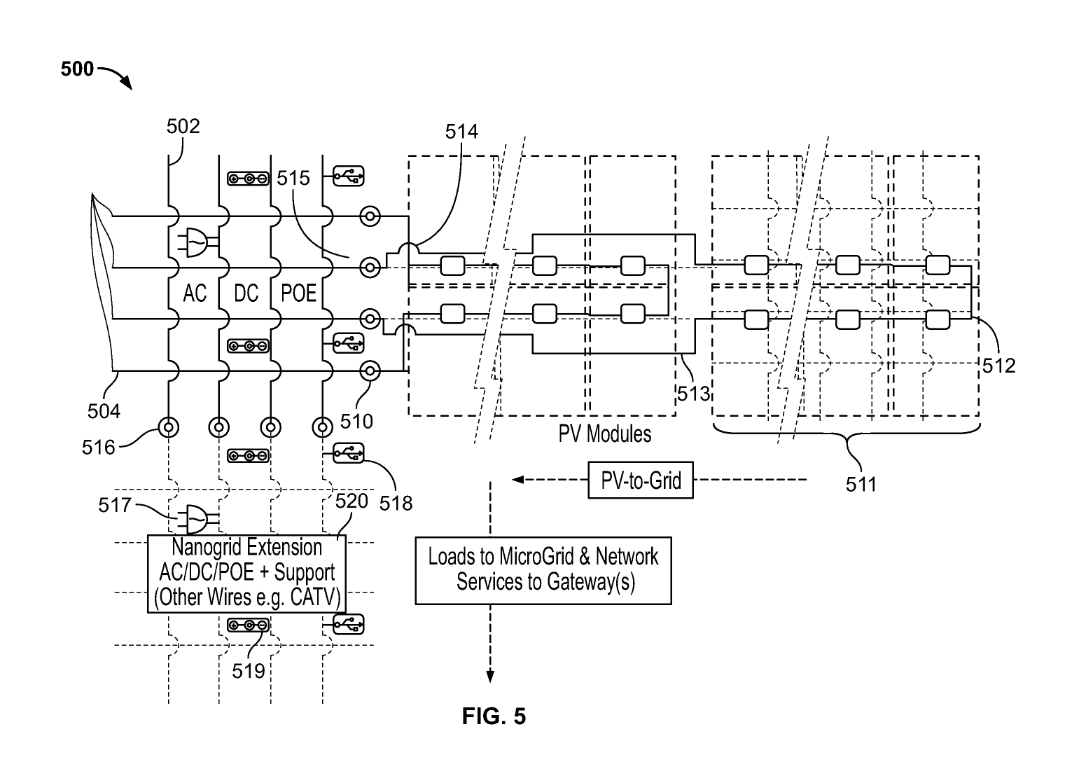

FIG. 5 depicts frame-beam wires 502, 504 of a frame 500, displayed vertically, corresponding to nanogrid wire sets for load and network circuits. One or more wires can be infused or enclosed within the material at the time of fabrication and/or after fabrication, such as, for example, during manufacturing assembly or even at an integration center that combines modules with frames. For instance, frame beams comprising the frame beam wires 502, 504 of FIG. 5 can be fabricated from wire lengths with fiber composite sleeves (with additional directional fiber layers where necessary) and resins. The frame beams 504 can be strengthened at joints with additional fiber materials. Alternatively, the structure can be assembled from poltruded and/or pre-formed, multidirectional fiber tubes, used as both structural beams and conduits that receive wires. Subsequently, multiple multi-directional fiber tubes can be combined a matrix with connectors. Composite wire-slats are feasible as well. Each of these approaches provides structural strength for supporting weight while simultaneously ensuring safety and protecting wires from external environment as well as theft and vandalism.

The frame-beam wires 502, displayed vertically in FIG. 5, correspond to the nanogrid wire sets for load and network circuits. Frame-beam wires 504, displayed horizontally, enclose solar wire extensions. Adjacent frames are connected structurally and electrically with connectors 510, 516. In some embodiments, solid rods or outer tubes may be combined with frame-beam wires, if needed depending on loading requirements, as an integration method, to enhance extension strength, and/or to enable compartmentalization, endcaps, or molding containments. Additionally, network and load circuits can physically run along the horizontal axis. This may be preferable for a one sided canopy or near ground applications. However, too many wires require larger support-conduits, a potential costly imbalance in overhead structures.

Although the drawings illustrate a 6-module frame designs, larger or smaller layouts are feasible via the same architecture. Based on inverter and conductor current-limitations, a solar set can include two frames with 6 PV modules wired in series (via DC strings or AC microinverter circuits shown in FIG. 5) sharing a single set of structural-electrical connectors. The PV extension 520 for the solar series begins by connecting a first frame (with the last leads of the series) to a first set of extension ports (items 512 to 513 to connector 510 below). The second series in the set is connected to another set of extension ports (item 514 to connector 515 below). With additional wire-beams or by doubling up extension wires within each beam, additional extensions are possible. Expanding sets (vertically as shown below) connects nanogrid wires via connector 516 as the structure. The canopy design depicted in FIG. 2 shows three sets connected horizontally via electrical-structural connectors that extend PV wires between the sets.

Optionally, lead wires that come with the modules can be covered or enclosed with covers that can vary in design based on the module supplier (e.g. lead length or AC panel) and/or the inverter option.

On the underside of the frames, a series of ports or jacks can be made available at points along the matrix, including AC jacks (port item 517), DC connectors (item 519) and/or Power over Ethernet ports (port item 518). PV conduits carry DC strings or AC circuits back to combiner/junction areas. Nanogrid conduits carry horizontal wires back to circuit breakers and network controls.

Although FIG. 5 shows a single thread for each of AC/DC/Ethernet lines, additional wires enable capacity/redundancy as well as including grounding and alternative media options such as specialized control wires or CATV lines. Current loading is ensured by limiting the number of ports/jacks per frame, the types of components and the number of frames per circuit. Combined and/or structured wiring groups with multifunction connectors are feasible as well.

Advantageously, layered composite structures open up a wide array of opportunities for the assemblage and configuration of smart frames. For example, sub-circuits and/or “logic layers” can easily be added to the underlying wiring matrix. In some embodiments, the material layers themselves can perform electro-mechanical, electro-thermal, acoustic and/or magnetics functions. Composites can add ultra-capacitance layers within the structure via combining fibers with graphene, metal flakes, conductive dusts or yarns, etc. Graphene-based wire-conductors are may be particularly advantageous, particularly in segmented, stiff structures (as opposed to bendable/stretchable wires). Phase change materials can draw heat, and thermal transfer honeycombs can move heat away to be used for another purpose. Thermo-electric generation materials can draw heat while producing electricity. Thus, design variations can leverage material properties to enhance PV nanogrid performance and functionality.

II. Multi-Function Wires Management System 104

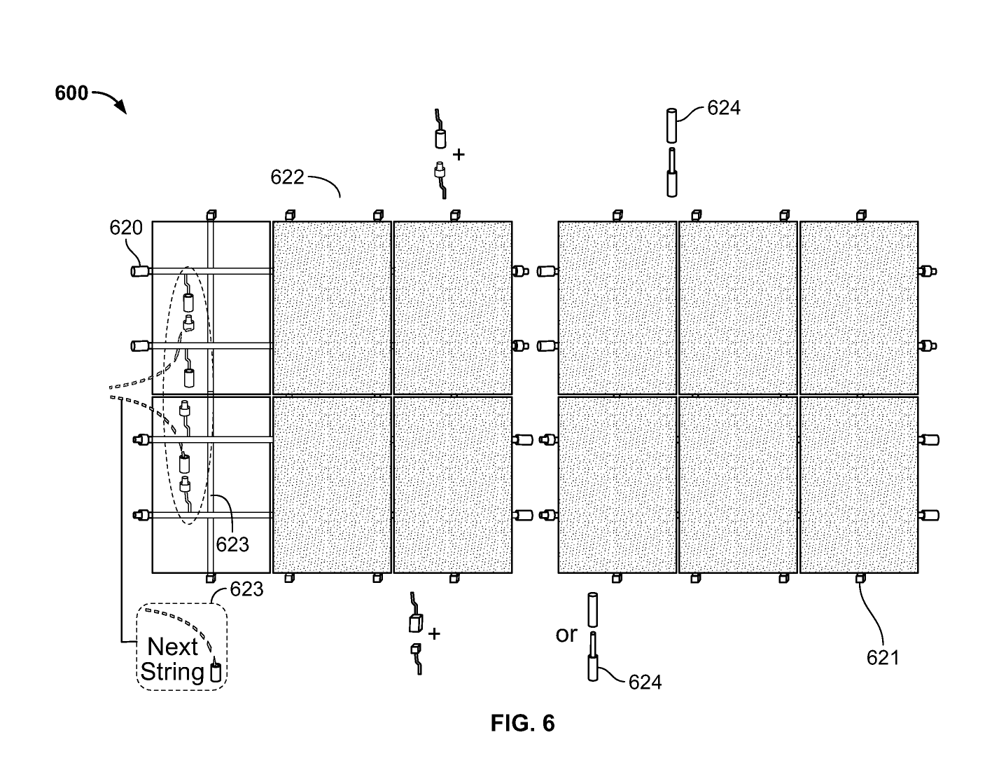

FIG. 6 shows a wire connector design of a basic frame 600, in accordance with some embodiments. Like the convention used in FIG. 5, the PV extension wires run from right-to left connecting to peer frames via extension connectors 620 while the electrical load and network wires run top-to-bottom connecting to peer frames via extension connectors 621. A 2-frame series connects the last lead wires to the peer frame extension wires 623. It should be understood that all of the wires could run along one axis or that wires from the same set could run in different directions. However, these alternatives could present material size, cost, interference, and safety issues. Additionally, installation quality assurance concerns might arise in implementations that cause confusion for installers.

Grounding wires are not shown but can run in either direction. It is conceivable to forgo grounding wires if composite materials qualify as a grounded-conductive matrix, in which case we electrical tabs and/or clamps could be provided for electrical continuity. Anticipated hybrid fiber variations might also have this characteristic as well as the ability to disperse lightning away from sensitive components, combinations of which could present certification and application tradeoffs. For instance, certain regions, e.g., where combinations of wind/snow/hail/lighting etc. are prominent, may require unique strength, wiring and topology variations.

As depicted in FIG. 6, PV modules are connected in series. However, in alternate embodiments, the PV modules could be connected as a microinverter AC circuit. The MC4 connectors 622 are widely available and advantageously eliminate the need to pull extension wires; although alternative integration connectors 624 are feasible for frame-to-frame extensions for both PV and other circuits.

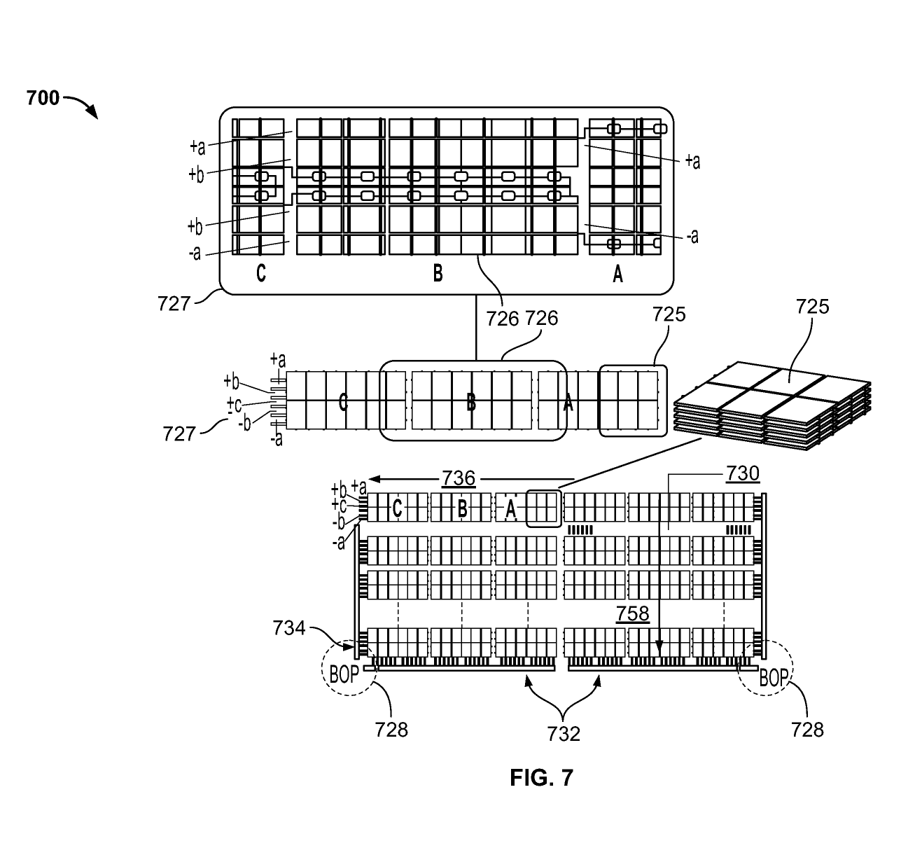

FIG. 7 shows a schematic view of modular frame PV expansion 700, in accordance with some embodiments. Current loading (for PV systems) is ensured by: (a) standardizing modules types (e.g. min and max) per frame and (b) layering each series by extending PV circuits back to a balance of plant area via conduits. FIG. 7 shows how two frames with 6 PV modules each (e.g., series 725) are structurally and electrically connected to form a PV set (e.g., set 726) and three PV sets combine together to forms one structural vector 727. Three PV circuits from structural vector 727 feed into an outer conduit. Set 726 shows the wiring connections of an extension series from the underside of the solar canopy.

Interconnected frames and conduits form a NanoGrid Structural-Electrical Matrix (also shown in FIG. 2). Overall, these drawings of structurally-integrated wires management systems illustrate that uniform structures with modular layouts can support two opposite facing vectors of up to six frames each with several dimensional options, from a single frame to 12×12 square (up to 864 modules for 6-module frames) or 12×N for rectangular canopies, depending on inverter and conduit limitations (12×8 are shown in FIG. 2).

The design shown in FIG. 6 might include up to 6 structural vectors with a total of 18 PV circuits, which are routed to balance of plant areas 728, which may include nanogrid and network wires 730, nanogrid conduits 732, solar circuits conduits 734, solar extension wiring 736, and grounding wiring 738. Balance of plant areas 728 may be provided at 1-4 vertices of the rectangular shaped configuration. Alternatively, inward facing series and conduits could route the PV circuits to one or more centrally located balance of plant areas. DC strings can be routed to central inverters, and AC microinverter circuits can be routed to breakers and/or transformers via extensions within conduits. Although a rectangular design is shown in FIG. 6, it should be understood that angular and hybrid vector variations (non-rectangular) are also feasible, supporting canopy geometry options such as octagons or star/flowering layouts, etc.

III. Structural-Electrical Integration Systems 106

The ability to reduce installation steps and, preferably, entire categories of labor is essential to improving the “deploy-ability” of photovoltaics. The assembly objective is for one connection step to enable electrical and structural integrity of the frame layer, which can thereafter be supported by a substructure.

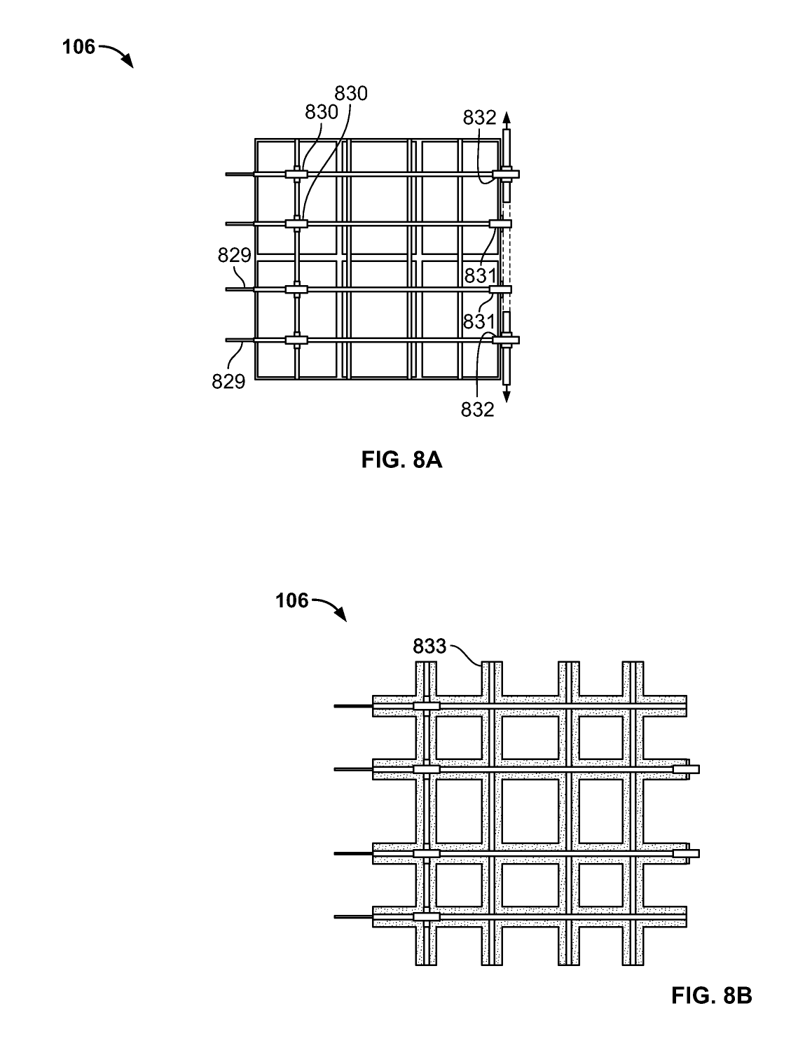

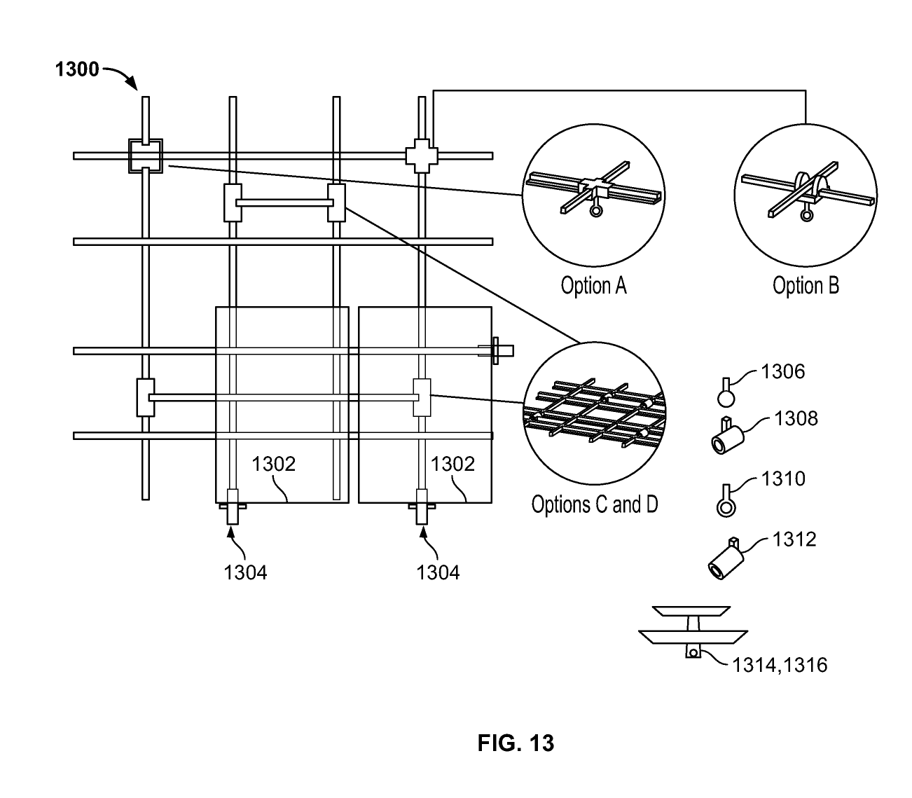

FIGS. 8A and 8B show schematic views of various frame-to-frame structural extension members 106, in accordance with some embodiments. The structural extension members depicted include:
(a) Rod extensions (829) extending from the frame in order to be inserted into a tube of an adjacent frame,
(b) Under-coupler (830) can act as either a firm integration point between frames or an independent frame to substructure option, such as a suspension cable or vertical tracker mount;
(c) Simple extension couplers (831);
(d) Extension couplers that connect to substructures (832) including beams, cables, and tubes; and
(e) Structural variations (composite slats and tubes 833) that enhance other characteristics while enabling ultra-strong extensions, such as slat/tube combinations depicted in FIG. 8B or integrated truss systems that include extensions (shown in below in FIGS. 13-16).

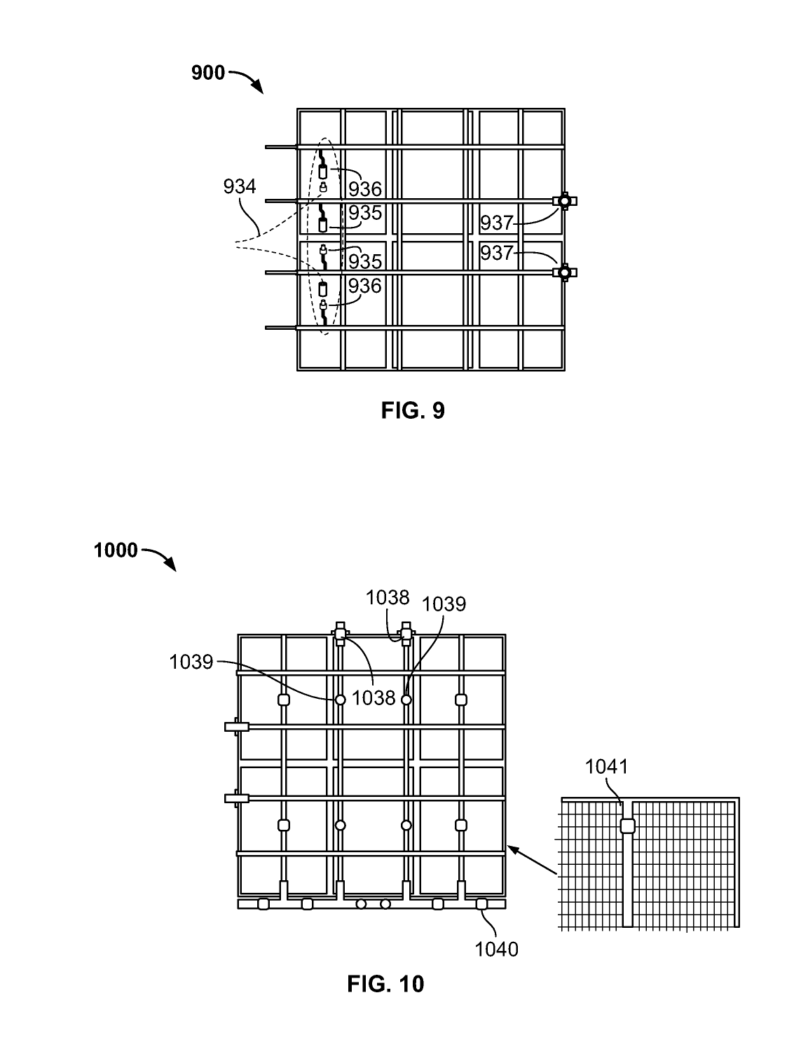

FIG. 9 shows a schematic view of string-to-extension connector options 900, in accordance with some embodiments. Each 2-frame set has lead wires from two sides of a DC-string (2-3 wires for an AC-circuit) that must be connected to embedded extension wires via connectors (935 and 936). For a 3-level extension, the first frame-set connects to connector 935) and the second to connector 936.

The various string-to-extension wiring connector options depicted in FIG. 9 include
(a) a standard wiring connector (to the solar extensions) extending from the side of the support tube (i.e., connectors 935 and 936); and
(b) a coupler acting as extension wire and lead wire integration points (937).
   Other electrical-structural integration techniques are feasible using similar layouts. These alternatives are displayed because there may be tradeoffs to consider depending on the type of frame used, including tube size/cost tradeoffs as a function of composite fiber tubing strength (e.g. drilling holes into a smaller composite tube creates the potential for damage so some designs might require larger composite tubes if this option is chosen).

FIG. 10 shows a schematic view of nanogrid port connector options 10000, in accordance with some embodiments. The various components of advanced PV and area enhancements (loads and data networks devices) must be connected to the circuits with some level of structural integrity. Below illustrates Nanogrid port connector options (DC/AC loads such as lighting and Power Over Ethernet plugs). Most extend from the under side of the frame as with connectors (extension bracket/coupler with ports 1038, ports embedded into sub frames 1039, outer framing with extension bracket/coupler and ports connectors 1040, while some may be exposed on top between panels as with for top side port connectors 1041 via an extended connector, coupler, frame spacer or inner frame design. These connector locations can have outdoor integration features such as watertight connections and/or component weight-bearing elements for optional network and/or electrical appliances.

As noted previously, high installation costs associated PV plants form a large barrier to wide adoption. The PV nanogrid systems disclosed herein beneficially reduce these costs by being amenable to automated module integration at a factory (or another point prior to installation). Additionally, the frame designs lend themselves to automated-installation methods at the installation site (e.g. robotics of the pre-assembled frames).

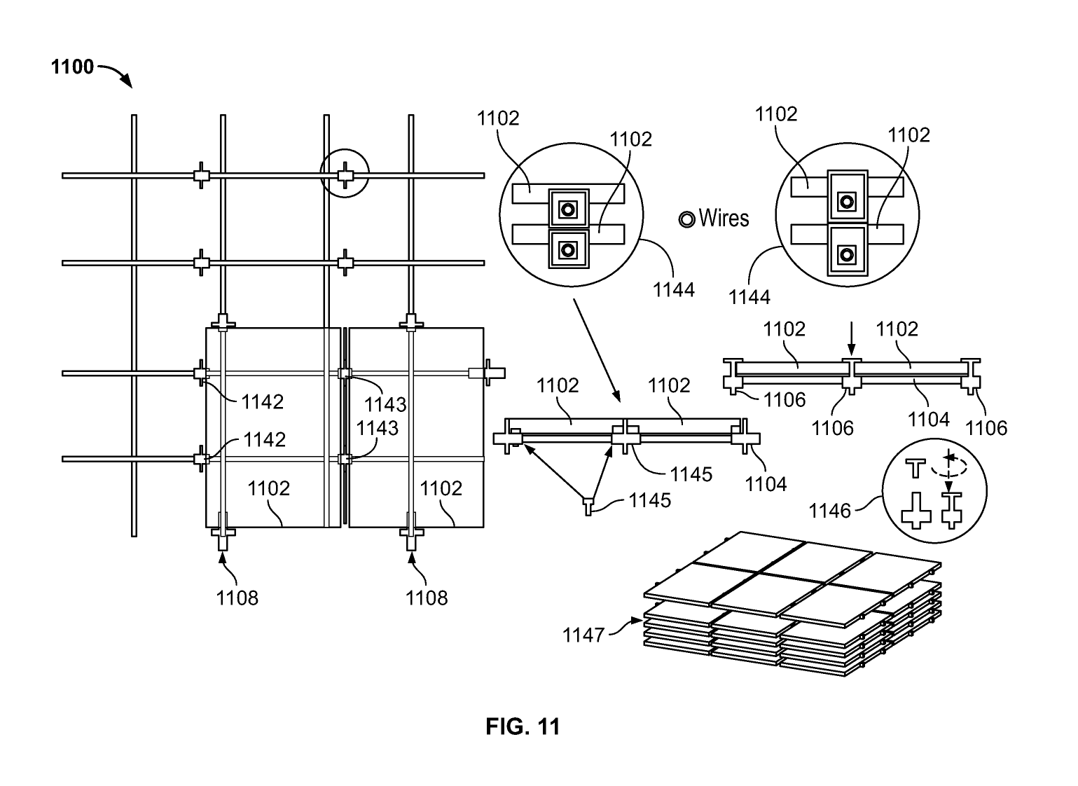

FIG. 11 shows various views of pre-assembly and module mounting features 1100 of a PV nanogrid system, in accordance with some embodiments. Module installation using PV nanogrid systems can be as simple as inserting a PV module 1102 into a frame slot provided with pre-molded mounting members (e.g. clips or brackets). However, the design depicted in FIG. 11 shows hardware capable of spacing and integrating modules of various dimensions to the underlying frame 1104. A simple frame spacer/bracket (1142, 1143) can include mounting bolts 1145 or clamps 1146. A stackable mounting bracket 1144 can be used as a footing between frames so that (in this case, roughly 10′×10′) frames can be preassembled (including wiring), stacked onto a modular nanogrid pallet 1147, and shipped as kitted units of power capacity before delivery to the installation area.

At the installation site, stacks of frames can be lifted up by elevated truck beds, cranes, extensible forklifts, pallet-lifting equipment, or robotic systems, for example, to be connected and mounted 6 PV modules at a time. Thus, the stackable frame approach can further reduce supply chain and installation costs.

### Integrating Frames to Substructures

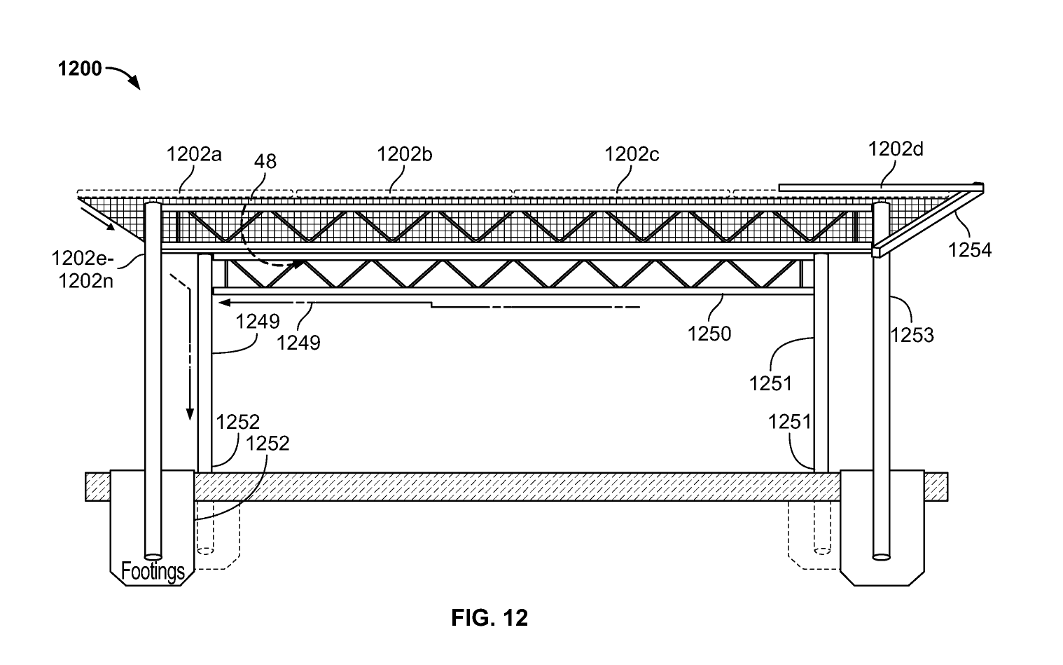

For purposes of illustration, following figures and related descriptions focus on integrating groups of frames to support and foundation structures. Architecturally, the conduits for wire extensions can be enclosed within canopy extensions (e.g. beams, horizontal truss or suspension cables) and outer molding designs and foundation support (e.g. poles or vertical trusses). Though physical layouts vary, the basic apparatus premise as depicted in FIG. 12 as well as the associated benefits remain consistent

FIG. 12 shows a perspective view of a PV nanogrid system 1200 including nanogrid frames 1202a-1202n, in accordance with some embodiments. The PV nanogrid system 1200 includes: frame to substructure integration point 1248, which might be include struts, support beams, trusses and/or cables in various embodiments; wire management directions 1249 that flow toward one or more balance of plant enclosures; horizontal support structure 1250, (a simple truss canopy extension illustrated in FIG. 12); vertical support to footing integration points 1251; vertical support structure 1253; footing system 1252 (concrete footings are shown in FIG. 12, but alternatives are feasible); and outer molding 1254, which can be used for architectural adornment, to support outer components like lighting/sensors, to enhance canopy strength and/or wind shear aerodynamics, etc.

Support structures can be made of frame-consistent materials, such as tubular truss composites. However, adding wire management systems to off-the-shelf aluminum and/or steel materials structures can achieve the same functional objectives.

As with any PV module support system, the extensible framing system disclosed herein can be mounted directly to near-ground struts. However, frames and substructures can be combined in numerous ways to raise the PV modules and enable canopy coverage configurations while also providing numerous functional, structural, and aesthetic options.

FIG. 13 shows various options for providing structural integration 1300 including PV modules 1302, and extension brackets 1304, in accordance with some embodiments. These structural integration designs can enable a diversity of under-structure configurations. In particular, FIG. 13 displays a tube-based framing structure, made of straight crossing supports with alternative methods of substructure integration (Options A-D). The hardware interface examples that provide the structural integration depicted in FIG. 13 include ball joints 1306, sleeve clamps 1308, loop brackets 1310, truss brackets 1312, axle brackets 1314, and truss systems 1316.

As illustrated in FIG. 12, simple crossbeams between poles can support small canopy structures. However, extending canopies over wider areas confronts a diversity of location types with the attendant need for foundation-to-structure optionality.

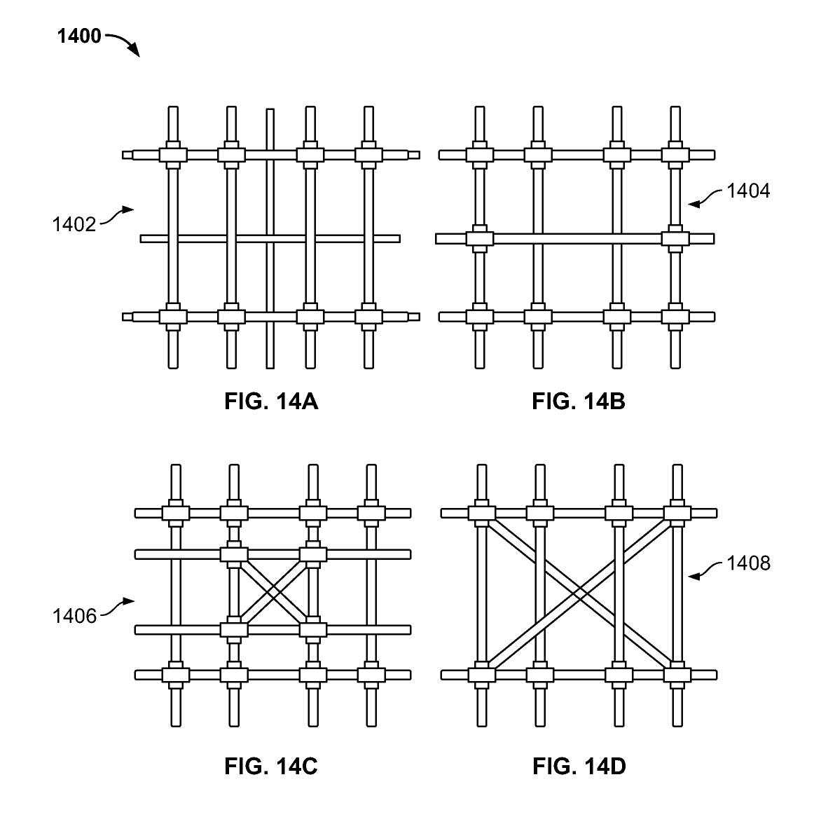

FIGS. 14A-14D show examples 1400 of suitable physical interfaces between frames and substructure, in accordance with some embodiments. The examples 1400 shown may include a tube/cable rails configuration 1402, a center tube configuration 1404, a center truss configuration 1406, and an outer truss configuration 1408. Rails, tubes, trusses and cables can be used to extend canopies and/or enable tracking. Fixed frames can be integrated with horizontal trusses, separate rails/beams, and/or structural cables. Rotating frames can mount to either a vertical or horizontal axle. Not shown, an inverse pyramid truss can connect at four points to enable fixed pods or an angular vertical rotation.

Using composite materials, truss systems can be integrated as part of the frame unit at the point of manufacturing or assembled later as truss kits.

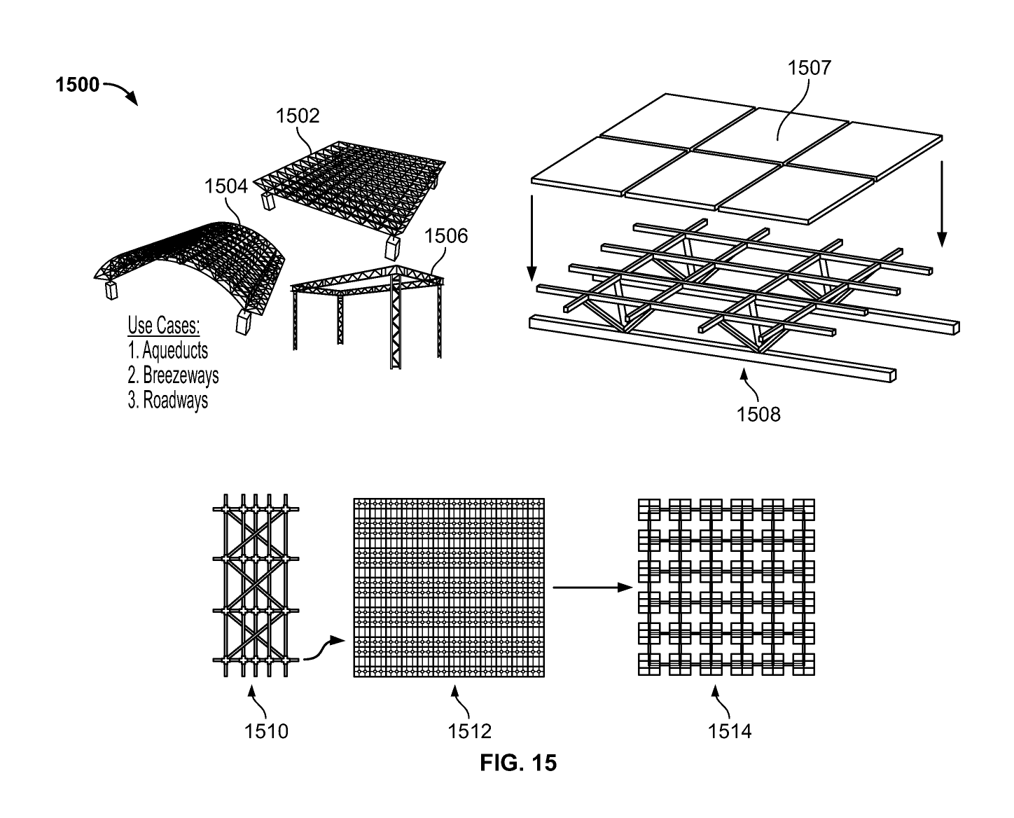

FIG. 15 shows various examples of truss supports 1500, in accordance with some embodiments. Examples include a flat truss 1502, an arch truss 1504, and a lite truss 1506. Truss options are also depicted, which may include a truss/rail beam variation 1508 for PV modules 1507, and an outer truss option 1510 including a truss canopy 1512 or a truss tracker canopy 1514. As shown in FIG. 15, the frame of a PV nanogrid system itself can form part of a uniform truss system (i.e., a kit). Trusses can operate as conduits for wires management and external ports. Not shown are the ports and jacks that might be fitted to the structure for energy space components that satisfy application and functional requirements.

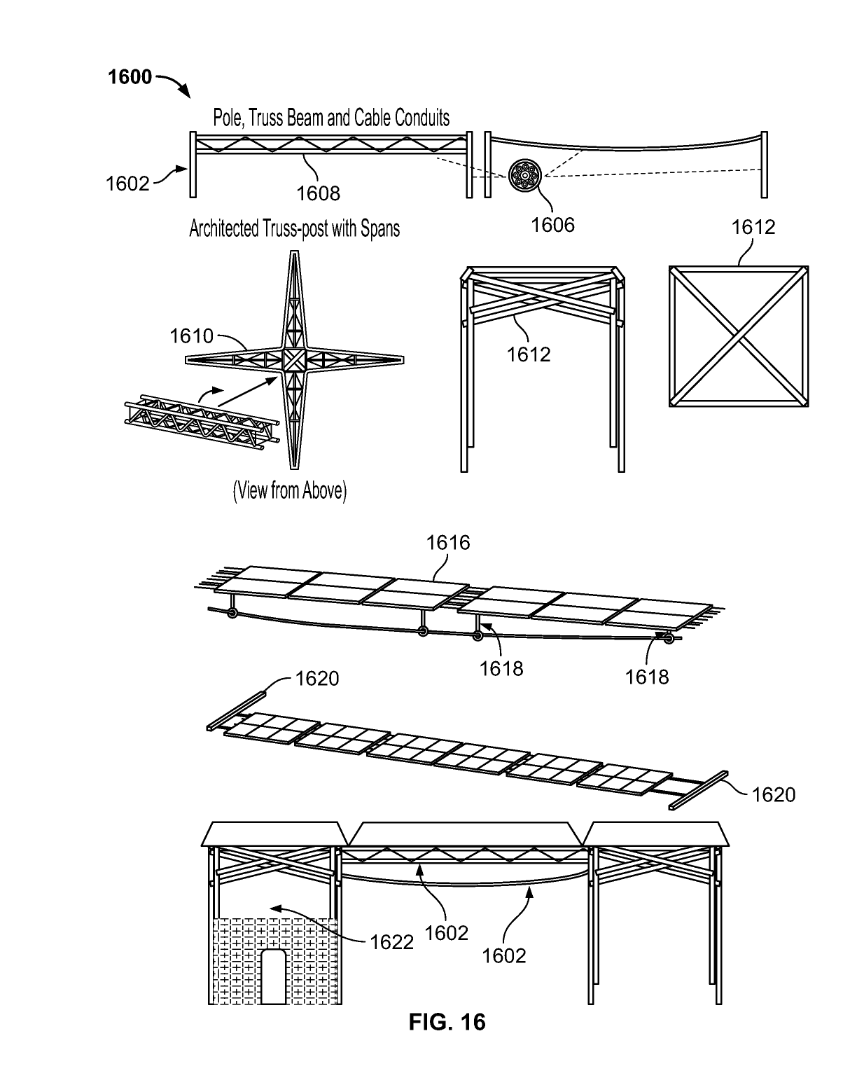

FIG. 16 shows various truss-pole and truss-cable variations 1600, in accordance with some embodiments. A truss 1602 may include poles, truss beams, and cable conduits 1606, 1608. The truss 1602 may have architected truss-post with spans 1610 or boxed truss-posts 1612. Item 1616 shows cable support to poles or other structures with height adjustment members 1618. The truss 1602 may include conduit supports 1620. The truss 1602 may include a secure BOP area 1622. Frames can be mounted on single pole/foundations, basic pole canopies (as shown in FIG. 12), multi-pole supports with enclosures for balance of plant equipment, suspension cables, or cable-truss combinations. Wires management can be embedded into any of these structures.

IV. Nanogrid Network Controllers 108

Although the PV nanogrid systems disclosed here can operate as a plant without additional controls, the ability to enable, adjust, switch and bypass is helpful for smart canopy applications of advanced photovoltaic resources. For instance, storage-enabled canopies can switch between charging from solar to charging from nanogrid circuits, to discharging at a later time period. Certain applications may require turning offload circuits on a frame-by-frame and/or port-by-port basis. Thus, controlling logical and physical elements can support the goal of encouraging pervasive expansion of renewable energy assets that benefit areas not typically amenable to PV installations.

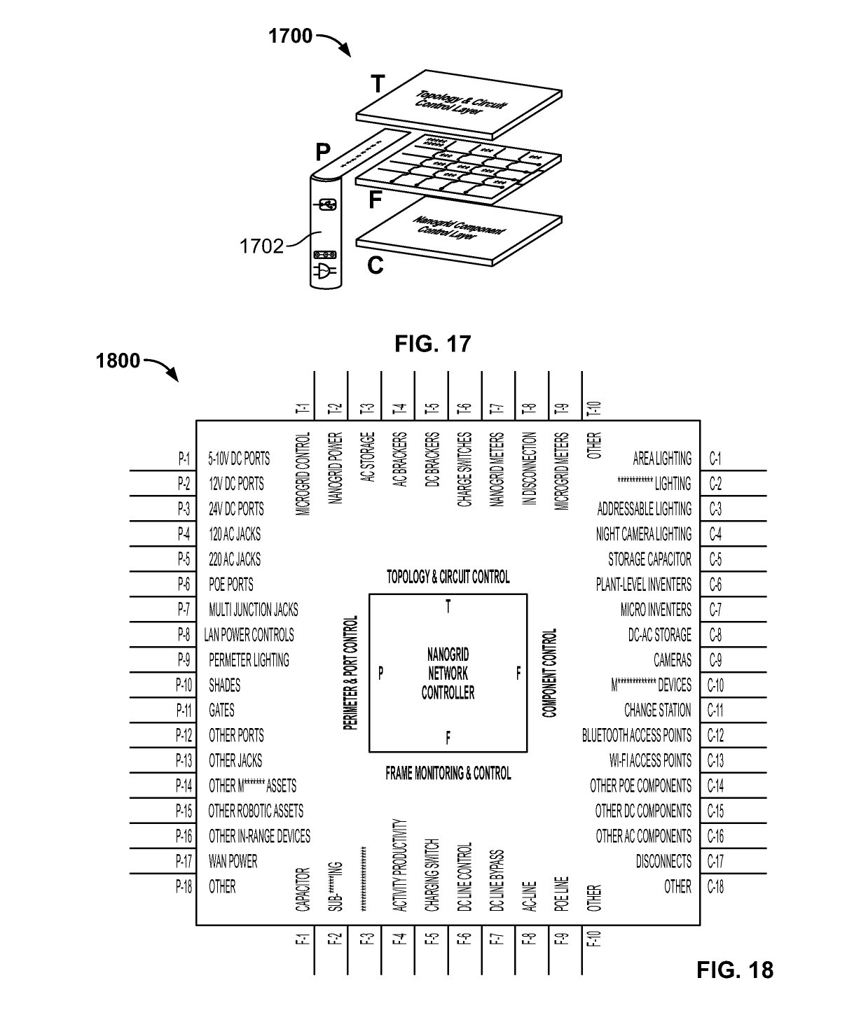

FIG. 17 shows a nanogrid control system framework 1700, in accordance with some embodiments. A physical or component layer 1702 can connect functional circuits (e.g. DC power controlled by POE driven components) and/or draw power selectively from PV, DC and/or POE. Additionally, dual-purpose components with on-board storage can charge and/or output power to inverters or usage points (e.g. lighting systems at night). By-pass circuits that are software selectable via networks yet physically redundant could allow very long NanoGrid extensions for continuous canopy applications as well as the ability to add circuits, network capacity, and network redundancy at later time periods, post initial-installation. These are just a few examples of potential advantageous control functions.

FIG. 17 shows several layers of control of the nanogrid control system framework 1700, including (“F”) the Frame Monitoring & Control layer, (“C”) the Component Control layer, (“T”) the Topology & Circuit Control layer and (“P”) the conduit perimeter layer and jack-port control layer having jack-port control circuitry 1702. Frames are populated with wiring layouts, ports and components to serve a class of application requirements. Since ports/jacks are present on both frames and structure, the control logic for these components can reside in one layer. Other categories, such as lighting circuits, can be physically and/or logically independent, and thus controls may be present in more than one layer.

FIG. 18 shows a schematic view of an exemplary Nanogrid Network Controller (NNC) 1800, in accordance with some embodiments. A NNC can interface via signal wires and/or IP communications with a diversity of subordinate and peer-level devices. NNC resources may be managed by cloud-based applications operating in various modes as sub-groups. It should be understood that some classes of application requirements require little intelligence at the frame level, while others require sophistication. Certain segments and components, regardless of application, may not be controlled, such as secure or 3rd part network services, for example. Highly available network requirements, such as border control or military bases, may require power or Ethernet redundancy with uniquely separate controls (or no control) over critical components, like thermal imaging cameras, for example. Certain applications may require two nanogrid networks to operate simultaneously, yet independently, across a common frame-matrix structure.

As a distributed, peer-level control asset of a microgrid network, NNC's can send signals to inverters, if necessary, to comply with interconnection and dispatch-control applications, or simply observe and adapt to status conditions, such as islanding. From a Microgrid perspective, the physical and logical architecture is intended to enable nanogrid building blocks to reduce the complexity of microgrid planning, construction, and operation. A network of nanogrid control systems will be able to operate as a fully compliant microgrid when combined with smart interconnection and control features of inverters and switchgear. From an area and subscriber management perspective, NNCs can be the manager of and interface to gateway services.

Control of multiple frames, components, and nanogrid canopies, along with MicroGrid control between canopies and grids, constitutes a scalable framework to support a diversity of advanced terrestrial power, contemporary infrastructure, and sustainable building applications.

V. Energy Space System and Subscriber Interfaces 110

Nanogrid canopy systems open up a wide array application diversity that might be called smart virtual-buildings. Like in typical smart buildings, specific “rooms” or “energy spaces” of a smart virtual-building can have designations and specific functions that networks serve. Unlike smart buildings, however, open areas include a mix of continuous spaces (e.g. aqueducts or roadways), and/or mobile spaces (e.g. moving walkways or shipping containers) with adjustable sizes and perimeter awareness conditions. Like the smart buildings of the future, however, wireless charging and/or robotic energy assets can move from space to space, being shared by users to leverage functional capital.

Microgrids are hardwired electricity networks that bridge the relationship between the regulated grid and the customer grid. As physical assets, nanogrids define a subset of a microgrid. However, nanogrids are smaller, modular designations of capacity and physical assets, and thus, able to serve area and subscriber specific needs. The intelligent area functions that serve specific subscribers are called Energy Spaces. In contrast to a default general-purpose area (e.g. a default under a canopy area), Energy Spaces can be application-limited areas with a fixed functional purpose, areas that change designation or modes. Energy spaces can span over multiple canopy areas and can even be apportioned areas underneath a single canopy.

Energy Spaces are, therefore, logical spaces, whereas canopies of nanogrid networks and component assets are the physical resources. In fact, Energy Spaces do not even require an overhead canopy. Rather Energy Spaces can be defined in physical areas surrounding a canopy, functional areas within network range, areas near mobile energy-charging stations, even near-canopy, moving-areas like escalators or sensor-video theatres enabled by drones that track and serve subscribers.

Any area near smart framing systems and enabled by network services can begin to serve multiple constituent, including, for example (a) land owner/managers, (b) friendly occupants, (c) reservation/renters, (d) ad-hoc subscribers, e) 3rd party services personnel, (f) vehicle owners, (g) vehicles, (h) automated roaming devices (e.g. drones), (i) animals, and (j) intruders.

A host of methods are available to classify users in order to activate services for a constituent of an Energy Space, such as using card-keys, finger print ID or other sensors, Bluetooth/Wi-Fi device exchange, RFID and camera recognition, etc. A user interface (UI) for classifying users can be provided via a smart phone application or presence/activity sensors and user input devices (e.g. speakers, microphones, cameras, keypads, etc.). Utilization of user input devices might be understood as an “intruder” interface, wherein a friendly introduction/warning is given to unexpected occupants who must either identify themselves or exit the area. It is important to recognize intruders who are uniquely friendly and generic from more harmful intruders that may be identified via security and surveillance systems added to a smart framing system. Such subsystems, for example, might further classify intruders as specific threat types (e.g. unauthorized personnel near army bases), vandals-thieves (e.g. unauthorized personnel near remote power stations), or illegal aliens (border control).

Thus, in the generic case an intruder might simply be classified as an unidentified friendly occupant and not classified as threat unless further subsystems make such as classification. This architecture allows advanced security and surveillance systems to perform their functions without logical dependency on the UI of the Smart Energy Space. Device and data exchange protocols can allow the two systems to share information and/or components, or not, choosing dedicated components. The same principal might be applied to electric vehicle (EV) charging networks, wherein user designations are integrated or separate. The Energy Space might control the energy to generic charging stations and/or charge-station network service providers can activate assets under a power exchange arrangement with the canopy asset owner and/or grid. Discussed below are a number of Energy Space applications.

Overhead and Perimeter Plants are basic extensible PV nanogrid systems capable of being installed in areas not typically suited for PV installations. The simplest UI is for a dedicated PV power plant that requires energy connectivity, security and, in some cases, habitat monitoring. A second scenario presumes that PV assets fill-in legacy solar facilities to leverage the unusable areas in and among the present plant's footprint to increase capacity. A third scenario presumes that PV assets surround legacy power facilities, renewable or non-renewable as a secure perimeter.

Linear Infrastructure Plants can be built along linear areas, such as aqueducts, train tracks, roadways. Linear infrastructure plats are especially well suited for areas that serve the public, require security, and in some cases surveillance of the surrounding area, and identify intruders before they enter the area.

Community Systems Frameworks may be well suited for installation in common public spaces. Accordingly, energy spaces can serve a community area during public hours and identify intruders when the public space is closed. Intruders can be converted to friendly occupants by default during public hours and/or upon identification or registration. Once authorized, users may be entitled to limited functionality depending on their level of subscription. A default subscription level is given to friendly occupants. Ad-hoc subscribers are those that require specific resources for a limited time period or service level, such as a charge station. A group that reserves a public space may be given unique priority feature sets over default subscribers for a calendared duration. A friendly occupant that does not have a smart phone might be instructed to use basic hand gestures to turn on overhead fans or dim the lighting at night.

Campuses and Defined Area Frameworks may be particularly well suited for educational and commercial campuses. Many universities, schools and commercial campuses want to participate in sustainable energy projects while adopting technologies that dissuade crime and protect privacy. High fences and roof-mounted cameras do not discourage or record crimes that occur in unseen areas, which account for most of these geographies. In fact, adding cameras to older structures is costly due to the need to pull wires. Additionally, schools want to serve their students with secure WiFi and encourage outdoor activities and study. Smart canopies are friendly locations that provide such coverage throughout a campus while reducing the cost of electricity. Students, teachers and employees might be classified as primary subscribers that can be authorized via smart phone and tablets, for example. Canopies can be used to charge student devices (e.g. USB or controllable AC plugs for Laptops. Temporary subscribers without an ID can use temporary and token resources.

Smart Parking Systems Framework. Upon entry, a vehicle can be identified by size, smart phone and license plate. A vehicle owner might be given an LED or brighter lighting path from the point where they enter a parking area on foot to location their vehicle.

Military Bases and Prisons. Military facilities often want to dissuade animals and people from entering. Prisons want to keep inmates within the perimeter. A smart perimeter system can easily delineate direction and identify authorized entry before dispatching on-site personnel.

VI. Smart Canopy Customization Options 112

Wide ranges of customization options for PV nanogrid systems are possible. The particular custom functionalities of a given system may be driven by the application requirements as well as the sponsors of renewable energy. For instance, a prison may want to expand usability of its outer perimeter for exercise so that it can open up inner capacity for other purposes. A wealthy city may wish to be identified as innovative, attracting people to areas in hopes of inspiring social interaction and sustainable development. Low-income areas may benefit from increased surveillance and Wi-Fi Internet coverage protecting citizens affordably while spreading the benefits of technology to the less fortunate.

There are numerous architectural adornments that allow canopies to serve communities, universities, communities and governments:
1. Smart Truss Systems. Tubular support systems can extend circuits to key ports and components. An overhead truss canopy system can extend lighting and other circuits downward to the under ceiling area (the layer below frames). An extension beam that supports the frame can encapsulate key circuits that serve under specific loads, such as 220 v AC for vertically mounted charging stations (see below).
2. Smart Edges. Molded rims around outer frames (as well as inner architectural segments) can encapsulate connectors for sensors and camera. Smart edges can be used to activate canopy sensor-awareness modes and locate hidden day/night-cameras that point outwards.
3. Smart Exterior Area Lighting. Adjustable brightness outer area lighting can be used to replace streetlights for community roads and parks. High-intensity, controllable direction lighting can dissuade unwelcome intruders form plants and aqueducts, giving the impression that lights are tracking intruders via thermal imaging and/or activity tracking sensors. Customized addressable lighting strings (along the edge) can activate automated sequences for ad hoc conditions, special events and holidays.
4. Architectural Tracking Systems—a solar tracker on subsets of frames can allow natural light to enter the area. The combinations of flat frames, angled frames and tracking frames can simultaneous improve performance and improve the attractiveness of canopy areas.

There are numerous operating systems that can help to manage distributed photovoltaics using intelligent energy spaces and allow canopies to serve communities, universities, communities and governments:
1. Automated Maintenance Platform. A suspended motorized elevator platform can lift robotic equipment that roams from canopy to canopy (space to space).
2. Automated/Robotic Cleaning. Sensors, markers and Wi-Fi can help direct robots to clean the underside and topside of solar canopies.
3. Automated/Robotic Azimuth and Tracking. A motorized under canopy robot can make seasonal adjustment to fixed angle canopies or rotate individual frames at several points throughout the day.

There are numerous operating systems that can help to manage smart parking and ad hoc energy subscriber features:
1. Vehicle Location and Space Notification. Frame-based sensors can map the under canopy area of parking lots and track vehicles, paring users with open spaces and reminding them of their vehicle location via an overhead LED track, brightness or color level, and/or smart phone mapping.
2. Vertically-mounted and Retracting Charging Stations. A charger mounted to overhead frames, beams or trusses can either be fixed or drop down upon the presence of authorized subscriber and/or EV car presence. This approach obviates the need to trench between charge locations.
3. Mobile EV Charging Stations. A motorized overhead charger that moves from space to space, allowing all the spaces to be EV-enabled without having a fixed charger per parking space. This approach obviates the need to install many charging stations in anticipation of temporary or peak activity.
4. User-Smart Jacks. The ability for USB and AC ports to be enabled in the presence of an authorized user, setting time and/or power limits for ad-hoc subscription. This means that outdoor areas can serve users without allowing unauthorized loads to be connected to the energy assets.

There are numerous applications to which the social canopy systems appeal:
1. Robotic cleaning of under/near canopy areas. Patios, parking areas and gardens can be attended by robotics served by intelligent canopy networks.
2. Smart Fans, Shades and Misters. Overhead fans, outer shades and misting systems can automatically operate on temperature thresholds or irradiance sensors or automatic schedules, yet be adjustable by users.
3. User-Controllable Space Heaters. Interspersed speakers throughout the canopy area can serve users with adjustable volume that diminishes when multiple users are present, requires social voting and/or implements a token Bluetooth game where alternating subscribers can play their music.
4. Musical Canopies. Interspersed speakers throughout the canopy area can serve users with adjustable volume that diminishes when multiple users are present, requires social voting and/or implements a token Bluetooth game where alternating subscribers can play their music.
5. Smart Acoustical Tiles. An under canopy layer that suspends below the frame can incorporate sound absorption, speakers, microphones and lights. The tile could be directionally adjusted for outdoor concerts or group acoustics (i.e. defining an smaller area underneath a canopy).
6. Smart Interior Area Lighting. Adjustable brightness levels can adapt to user-presence and/or be adjustable via the user interface.
7. Multi-subscriber Outdoors Video Entertainment. Fixed or retracting TV monitors can allow users with smart phones to watch TV, YouTube, video games etc., interacting from their phone and listening on their headsets yet viewing larger screens from above.
8. 3D Virtual Video Booth. Multi-dimensional cameras can enable 3D-Selfies video and/or outdoor video conferencing. Images can be sent to the users phone.

There are numerous terrestrial applications to which the above systems appeal:
1. Microcell mini-tower stations. A powered (with backup), plug-in area for hosting 3rd party cellular as well as outer area Wi-Fi coverage (private or public) may be provided. Extended Wi-Fi is valuable to community parks, subsidized low-income housing development as well as agricultural sectors for crop monitoring, irrigation and harvesting systems.
2. Smart drone stations. Landing-charging-communications locations for advanced drones that also connect canopy cameras with mobile theater conditions can be provided. The ability to manage multiple drones on an extensible cellular basis is extremely relevant and valuable to border security. In agricultural applications, drones that monitor chlorophyll levels and other crop conditions during the day can switch at night to security and/or animal tracking.

There are numerous smart environmental and physical applications to which the above systems appeal:
1. Automated Rain gutters and related water filtration systems. The rain gutter system can surround the canopy and/or exist between segments. The automated features include controllable ports, gutter dumping/cleaning, filtration/cleaning sensors, misters (for hot climate) as well as interface(s) to water recycling systems. This enables the dispersion of water like any gutter, as well as cooling areas and recycling rain and canopy cleaning.
2. Presence-Temperature activated fans
3. Habitat Systems. Animal-monitoring cameras can identify species (and predators), photograph poachers, monitor climate and activate feeding troughs for endangered species and cattle. Special bird mounts/nests can reduce the cost of monitoring and propagating threatened species. While feasible today as isolated nature strategies, the cost and scale of these approaches becomes infinitely more practical with extensible smart canopies. Instead of fighting environmentalists, developers can sponsor habitat development near assets.

There are numerous secure area adaptations that allow perimeter canopies to secure facilities, military bases, border control and outer prison areas:
1. Virtual fences. A defined outer perimeter can warn intruders of secure area that they have crossed a line.
2. Automated fences, gates/vertical doors and netting. Fencing between supports can retract to either side. Gates or vertical doors can open and close via remote control based on user authorization. Netting can drop and retract as intruders approach.
3. Robotic sentries. Drones and or mobile robots can respond to canopies if verbal warnings are not.

Nanogrid Solar Applications may be particularly well suited for the following types of installations:

Ultra-light Rooftop Applications. Although the frame wire systems are targeted at smart area canopies in open property areas, the ability to address roof weight/support issues is an added value for rooftop canopies and/or near roofline mounting. Smart-shaded rooftops for outdoor dining or socialization areas are added benefits for upgrading existing structures for sustainability while enhancing space utilization. Like other roof-level mounting systems, ballast based supports with cable anchors can expands roof-mounted solar options for weaker rooftops, however address the challenge of rooflines with too many shading obstructions by raising stronger/lighter structures to optimum heights.

Over Roof/Structure Applications. Some rooflines (e.g. rounded industrial buildings) are both weak and angular. A canopy can exist as a separate structure above the building, where supports run vertically as posts at the edges of the roof or near the base-sides. Certain structures, such as multi-level parking facilities and freeway off-ramps/overpasses could have covered canopies with or without using the structure as a foundation.

Ultra-light Roofing Material Applications. Although frame-wire systems shown in previous drawings are based on open framing, variations that enable roof material like covering, such as outer framing with sealing or the sub-panel variations with flexible thin-film panels and overlapping/sealing can form a roof-like material option, usable for a wide range of building application, such as covering barns, warehouses, electrified and occupied shipping containers applications. The ability to add lighting and other functional elements adds value to the roofing construct.

Soft Soil/Suspended Applications. Like the rooftop scenario, certain ground mounted solar plants are infeasible on soft soil and sensitive areas. An overhead system with ballasts, under-framing and/or fewer footings with canopy spanning can address many of these conditions. The ability to add movement/tilt sensors, secure wiring and security features bolsters risk management within these environments.

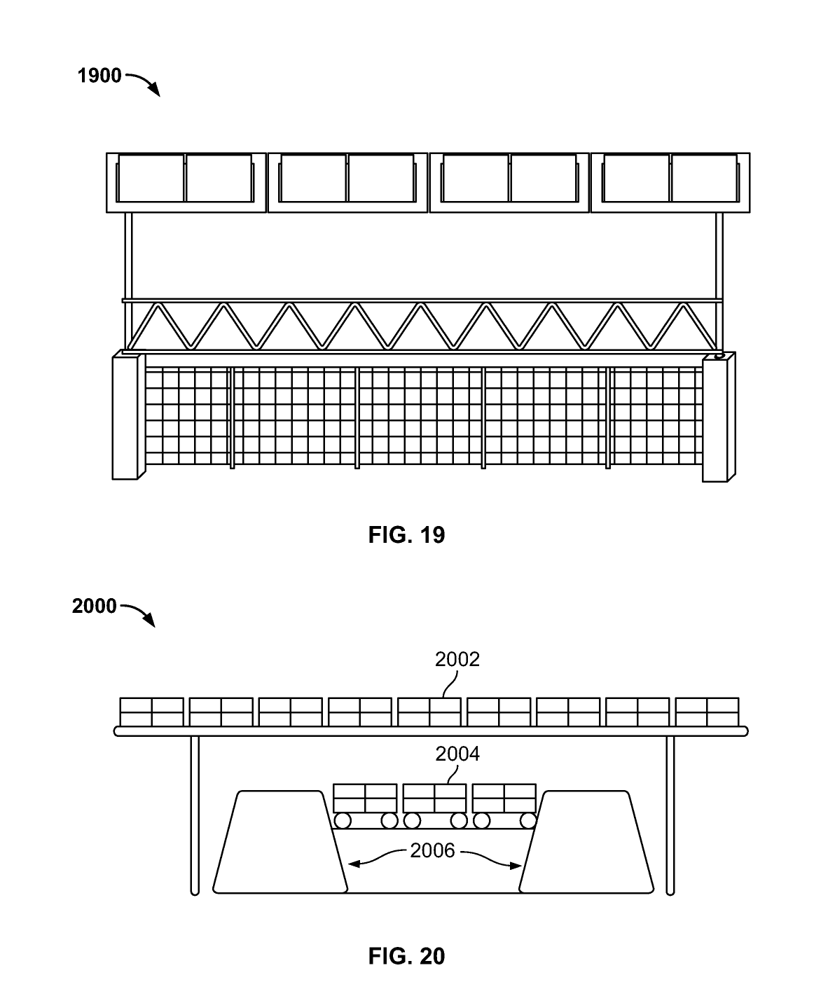

Perimeter Plants and Border Control. Numerous applications exist for surrounding and filling in functional-renewable coverage to existing properties, including gridscale power plants, military bases, campuses, and planned-enclosed communities. Each of these areas can secure perimeters while adding renewable capacity. Additionally, a smart frame structure can be combined with an outer physical perimeter fence and observation deck. An exemplary nanogrid system 1900 for use in perimeter plants and border control is shown in FIG. 19.

Linear Infrastructure Plants. Like perimeter plants, extensible infrastructure markets lie near grid capacity. These include aqueducts, pipelines, roadways and trains. An extensible and distributed plant architecture that enables terrestrial security and monitoring features is an attractive option. For aqueducts, the advantages, of elevated solar, relative to pontoon systems include (a) 2-3× the capacity per linear mile and (b) better irradiance exposure due to eliminating shading from concrete and near duct vegetation. An exemplary nanogrid system 2000 for use as a linear infrastructure plant above an aqueduct is shown in FIG. 20. The nanogrid system 2000 may include a smart canopy 2002, pontoons 2004, and an aqueduct member 2006.

Campus and Community Area Canopies. Ground mounted, roof-mounted and heavy parking structures are infeasible for numerous areas. Each requires a sacrifice, adds unnecessary costs and disruption to community open spaces. An overhead system with ballasts, under-framing and/or fewer footing with canopy spanning can address many of these conditions. The ability to add movement/tilt sensors and security bolsters risk management within these environments

It should be understood that the aspects, features and advantages made apparent from the foregoing are efficiently attained and, since certain changes may be made in the disclosed inventive embodiments without departing from the spirit and scope of the invention, it is intended that all matter contained herein shall be interpreted as illustrative and not in a limiting sense.

What is claimed is:

1. A photovoltaic nanogrid system, comprising:
one or more pre-wired frames each having a top, sun-facing side configured to receive one or more photovoltaic (PV) modules mounted thereon, wherein the one or more pre-wired frames comprise electrically and structurally connected support beams connectable to the one or more photovoltaic modules;
a wire management system embedded within the one or more pre-wired frames comprising modular conduits that gather and route wiring to/from the one or more pre-wired frames; and
a structural-electrical integration system to support the one or more pre-wired frames and to route power among the one or more pre-wired frames.

2. The photovoltaic nanogrid system of claim 1, wherein the one or more pre-wired frames further comprise one or more electrically and structurally connectable support beams and/or multi-layered sub-panels connected to an under side of the one or more pre-wired frames.

3. The photovoltaic nanogrid system of claim 2, wherein the one or more sub-panels comprise a wire/tube matrix fabricated from composite materials, wiring, and connectors.

4. The photovoltaic nanogrid system of claim 3, wherein the composite materials are formed from a single fiber type.

5. The photovoltaic nanogrid system of claim 1, wherein an under side of the one or more pre-wired frames further comprise one or more ports and/or jacks to integrate under-canopy components comprising one or more of a microinverter, lighting, a sensor, a battery, or a charger.

6. The photovoltaic nanogrid system of claim 1, wherein the one or more pre-wired frames are assembled from poltruded and/or pre-formed, multidirectional fiber tubes, used as both structural beams and conduits that receive wires.

7. The photovoltaic nanogrid system of claim 1, wherein the one or more pre-wired frames are further assembled from one or more of fiber tubes, solid rods or outer tubes combined with frame-beam wires.

8. The photovoltaic nanogrid system of claim 1, wherein, a series of ports or jacks are located at points along support beams on an underside of the one or more pre-wired frames.

9. The photovoltaic nanogrid system of claim 1, further comprising at least one of a sub-frame matrix mounted underneath the one or more PV modules, outer framing members that surround and enclose the one or more PV modules, a composite cable matrix mounted under and/or around the one or more PV modules, combinations of module-enclosed frames with cables and/or composite wires mounted beneath the PV modules, a frame with enclosed trackers that allow one or more of the PV modules to rotate within the one or more pre-wired frames, a sub-panel comprising a solid frame that provides roof-like coverage and/or support for thin film PV modules, or ceiling tile-embedded wiring and component integrations systems comprising wired ceiling panels suspended below framed PV modules.

10. The photovoltaic nanogrid system of claim 1, further comprising frame embedded wire management and extension points to permit groups of PV modules to be installed as power units.

11. The photovoltaic nanogrid system of claim 1, further comprising routing wires to combiner conduits that facilitate the interconnection between individual PV nanogrid systems.

12. The photovoltaic nanogrid system of claim 1, wherein the modular conduits of the wire management system route PV extension wires running from right-to left connecting to peer frames via extension connectors and route electrical load and network wires running top-to-bottom connecting to peer frames via extension connectors.

13. The photovoltaic nanogrid system of claim 1, wherein the structural-electrical integration system supports a matrix of one or more frames and one or more conduits to route power and other electrical loads.

14. The photovoltaic nanogrid system of claim 13, wherein the one or more conduits are enclosed within canopy extensions comprising one or more of beams, horizontal truss, or suspension cables.

15. The photovoltaic nanogrid system of claim 13, wherein the one or more conduits further comprise hardware interfaces that provide structural integration.

16. The photovoltaic nanogrid system of claim 15, wherein the hardware interfaces comprise one or more of ball joints, sleeve clamps, loop brackets, truss brackets, axle brackets, and truss systems.

17. The photovoltaic nanogrid system of claim 1, further comprising one or more network controllers configured to manage one or more components of the photovoltaic nanogrid system.

18. The photovoltaic nanogrid system of claim 17, wherein the one or more network controllers are configured to manage one or more of the PV modules, inverters, switches, storage, loads and data network circuits, ports, or jacks.

19. The photovoltaic nanogrid system of claim 17, wherein the one or more network controllers each comprise:
a layer to monitor and control the one or more pre-wired frames;
a layer to control components; and
a layer to control a topology of the system.

20. The photovoltaic nanogrid system of claim 17, wherein the one or more network controllers are configured to partition the system into intelligent area functions that serve specific subscribers.

21. A photovoltaic nanogrid system, comprising:
one or more photovoltaic (PV) modules mounted on a top, sun-facing side of one or more pre-wired frames, wherein the one or more pre-wired frames comprise electrically and structurally connected support beams connectable to the one or more photovoltaic modules;
a wire management system embedded within the one or more pre-wired frames comprising modular conduits that gather and route wiring to/from the one or more pre-wired frames; and
a structural-electrical integration system to support the one or more pre-wired frames and to route power among the one or more pre-wired frames.

22. The photovoltaic nanogrid system of claim 21, further comprising one or more network controllers configured to manage one or more components of the photovoltaic nanogrid system.

23. The photovoltaic nanogrid system of claim 22, wherein the one or more network controllers are configured to partition the system into intelligent area functions that serve specific subscribers.
